(19) United States
(12) Patent Application Publication
(10) Pub. No.: US 2019/0051096 A1
(43) Pub. Date: Feb. 14, 2019

(54) Gaming Machine and Method with Repeat Win Trigger

(71) Applicant: Ainsworth Game Technology Limited, Newington (AU)

(72) Inventor: Kin Wai San, Maroubra (AU)

(21) Appl. No.: 15/676,092

(22) Filed: Aug. 14, 2017

(51) Int. Cl. G07F 17/32

(52) U.S. Cl. CPC G07F 17/326; G07F 17/3213; G07F 17/3209; G07F 17/3251; G07F 17/3246

(57) ABSTRACT

A gaming machine comprises a display and an electronic controller for playing a first game. A bonus prize value award is calculated from the multiplier selected by the electronic controller and a wager made by a player. The bonus prize value award is associated with a trigger event. When the trigger event occurs in the first game, the bonus prize value award is paid to the player. The multiplier may be randomly selected from a range of multipliers or selected based on a number of special symbols collected by the player. The trigger event may be the appearance of one or more special symbols or a designated configuration of game symbols.

### BACKGROUND

The present disclosure relates to a gaming machine and method. The present disclosure has been developed primarily for use as an electronic gaming machine and will be described hereinafter by reference to this application. However, it will be appreciated that the present disclosure may also be implemented for any type of gaming machine, including a mechanical or electro-mechanical gaming machine.

The following discussion of the prior art is intended to present the present disclosure in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Conventional gaming machines typically involve awarding prizes to a player according to predetermined combinations of game symbols that appear on an array of game squares displayed on a screen, typically organised into three rows and five columns (a 5×3 array). Other arrays, such as a 3×3 or 4×3, may be used. Each gaming machine randomly selects the game symbols that appear on the array, each column of the array being a “reel”.

One type of gaming machine comprises a mechanical or electro-mechanical device, where a motor rotates a plurality of annular rings or drums that form reels. Each reel has a reel strip that displays game symbols in preset game symbol positions. A frame covers the rings to provide a window through which only a subset of game symbol positions (and hence game symbols) were visible to the player. Thus, for a game using a 5×3 array, the window would only permit three rows of five rings to be visible to create the game array. An internal electronic controller within the gaming machine controls operation of the motor and hence rotation of the reels. Thus, by controlling when each reel starts and stops in its respective rotation, the electronic controller controls the display of the game symbols in the window. Sensors linked to the reels indicate which game symbols are displayed in the window and communicate with the electronic controller so that the electronic controller is able to award prizes based on winning combinations of game symbols displayed on the reels in the window. The electronic controller typically comprises one or more electric circuits for controlling various functions of the gaming machine, such as the above mentioned control of the motor, communicating with the sensors, verifying that the correct amount of a bet has been made via one or more value receiving mechanisms to enable operation of the motors, controlling any visual and/or audio effects associated with operation of the gaming machine and controlling operation of various alarms to alert any tampering with the gaming machine.

Another type of gaming machine, known as an electronic gaming machine or EGM, replaces the mechanical reels and motor with a video display screen on which video images of the reels are displayed. The EGM has an internal electronic game controller, typically a computer, that controls the display of images on the video display screen so that the reels are visibly spun on the screen to simulate a physical reel of a traditional gaming machine. EGMs tend to be more versatile in providing game information, varying the probabilities for a player to win a prize and varying the type of game that is played.

Bonus or “feature” games may also be provided by a gaming machine in addition to a base or main game. Typically feature games use the same set of reels as the main game and are limited to a set of free games operated under a single set of rules. This means that the feature game is restricted by the same set of rules, and so there is no variation in the play of the feature game. Also, gaming machines can offer one or more bonus prizes to the player during play of the game. The most common type of bonus prize that is awarded by the gaming machine is a jackpot prize, the main example of which is a progressive jackpot prize.

This standard structure to game play and bonus prizes limits the operation of the gaming machine, irrespective of whether it is a mechanical, electro-mechanical or electronic gaming machine. Consequently, it is difficult to retain player interest because there is no apparent incentive for the player to continue playing the gaming machine once the player becomes familiar with the feature game, the main game and any bonus prizes.

It is an object of the present disclosure to overcome or substantially ameliorate one or more of the disadvantages of prior art, or at least to provide a useful alternative.

### SUMMARY

The present disclosure provides a gaming machine that has improved operation and performance relative to existing prior art gaming machines by providing a more efficient way of awarding prizes to a player of the gaming machine and in a more entertaining manner compared to presently existing gaming machines. The present disclosure also improves the application of an electronic controller in playing the game on the gaming machine.

One embodiment of the present disclosure provides a gaming machine comprising:

a display; and

an electronic controller coupled to a display;

wherein the gaming machine is configured to receive a wager from a player;

the electronic controller being configured to:
display a first game on the display including one or more configurations of game symbols, one or more of the configurations of game symbols being associated with a winning game outcome, the winning game outcome being associated with a value award payable to a player;
select a multiplier;
calculate a bonus prize value award from the multiplier and the wager;
associate the bonus prize value award payable to the player with a trigger event; and
pay the bonus prize value award in response to the trigger event occurring in the first game.

Another embodiment of the present disclosure provides a gaming machine comprising:
at least one display;
a value input comprising at least one of a coin acceptor, a bill acceptor and a ticket reader; and

at least one electronic controller coupled to the at least one display and the value input, the at least one controller configured:
to determine if a wager has been received via the value input;
to display a first game on the at least one display including one or more configurations of game symbols if a wager has been received, one or more of the configurations of game symbols being associated with a winning game outcome, the winning game outcome being associated with a value award payable to a player;
to select a multiplier;
to calculate a bonus prize value award from the multiplier and the wager;
to associate the bonus prize value award payable to the player with a trigger event; and
to pay the bonus prize value award in response to the trigger event occurring in the first game.

An additional embodiment of the present disclosure provides a gaming machine comprising:
a display; and
an electronic controller coupled to a display;
wherein the gaming machine is configured to receive a wager from a player;
the electronic controller being configured to:
   display a first game on the display including one or more configurations of game symbols, one or more of the configurations of game symbols being associated with a winning game outcome, the winning game outcome being associated with a value award payable to a player;
   select a multiplier;
   calculate a bonus prize value award from the multiplier and the wager;
   display a second game in response to the first trigger event occurring in the first game;
   associate the bonus prize value award with a second trigger event in the second game; and
   pay the bonus prize value award in response to the second trigger event occurring in the second game.

A further embodiment of the present disclosure provides a gaming machine comprising:

at least one display;

a value input comprising at least one of a coin acceptor, a bill acceptor and a ticket reader; and

at least one electronic controller coupled to the at least one display and the value input, the at least one controller configured:
to determine if a wager has been received via the value input;
to display a first game on the at least one display including one or more configurations of game symbols if a wager has been received, one or more of the configurations of game symbols being associated with a winning game outcome, the winning game outcome being associated with a value award payable to a player;
to select a multiplier;
to calculate a bonus prize value award from the multiplier and the wager;
to display a second game in response to a first trigger event occurring in the first game;
to associate the bonus prize value award with a second trigger event in the second game; and
to pay the bonus prize value award in response to the second trigger event occurring in the second game.

An additional embodiment of the present disclosure provides a method comprising:

displaying a first game on the display including one or more configurations of game symbols, one or more of the configurations of game symbols being associated with a winning game outcome, the winning game outcome being associated with a value award payable to a player;

selecting a multiplier;

calculating a bonus prize value award payable to the player from the multiplier and the wager;

associating the bonus prize value award payable to the player with a trigger event; and

paying the bonus prize value award in response to the trigger event occurring in the first game.

Yet another embodiment provides a method comprising:

determining if a wager has been received via a value input comprising at least one of a coin acceptor, a bill acceptor and a ticket reader;

displaying a first game including one or more configurations of game symbols if a wager has been received, one or more of the configurations of game symbols being associated with a game outcome, the game outcome being associated with a value award payable to a player;

selecting a multiplier;

calculating a bonus prize value award payable to the player from the multiplier and the wager;

associating the bonus prize value award payable to the player with a trigger event; and

paying the bonus prize value award in response to the trigger event occurring in the first game.

Yet another additional embodiment of the present disclosure provides a method comprising:

displaying a first game on the display including one or more configurations of game symbols, one or more of the configurations of game symbols being associated with one or more winning game outcomes, each winning game outcome being associated with a value award payable to a player;

selecting a multiplier;

calculating a bonus prize value award payable to the player from the multiplier and the wager;

displaying a second game in response to a first trigger event in the first game;

associating the bonus prize value award with a second trigger event in the second game; and

paying the bonus prize value award in response to the second trigger event occurring in the second game.

Yet another embodiment provides a method comprising:

determining if a wager has been received via a value input comprising at least one of a coin acceptor, a bill acceptor and a ticket reader;
displaying a first game including one or more configurations of game symbols if a wager has been received, one or more of the configurations of game symbols being associated with a game outcome, the game outcome being associated with a value award payable to a player;
displaying a second game in response to a first trigger event in the first game;

associating the bonus prize value award with a second trigger event in the second game; and

paying the bonus prize value award in response to the second trigger event occurring in the second game.

One further additional embodiment of the present disclosure provides a gaming machine comprising:

a display; and

an electronic controller coupled to a display, the electronic controller being configured to:
display a first game on the display including one or more configurations of game symbols, one or more of the configurations of game symbols being associated with a winning game outcome, the winning game outcome being associated with a value award payable to a player;
associate a first configuration of game symbols appearing on the display with a first winning game outcome, the first winning game outcome being associated with a first value award payable to the player; and
associate the first value award with a trigger event when the first configuration of game symbols appears in a play of the first game; and
pay the first value award to the player in response to the trigger event occurring in a subsequent play of the first game.

Another further additional embodiment of the present disclosure provides a gaming machine comprising:

a display; and

an electronic controller coupled to a display, the electronic controller being configured to:
display a first game on the display including one or more configurations of game symbols, one or more of the configurations of game symbols being associated with one or more winning game outcomes, each winning game outcome being associated with a value award payable to a player;
associate a first value award payable to the player with a first trigger event in the first game and a second trigger event in a second game;
display the second game in response to the first trigger event occurring in a play of the first game; and
pay the first value award to the player in response to the second trigger event occurring in a play of the second game.

A further additional embodiment of the present disclosure provides a gaming machine comprising:

a display; and

an electronic controller coupled to a display, the electronic controller being configured to:
display a first game on the display including one or more configurations of game symbols, one or more of the configurations of game symbols being associated with one or more winning game outcomes, each winning game outcome being associated with a value award payable to a player;
associate a first configuration of game symbols appearing on the display with a first winning game outcome, the first winning game outcome being associated with a first value award payable to the player;
in response to a first configuration of game symbols appearing in the first game, pay the first value award to the player and display a second game on the display;
wherein the second game is different to the first game and includes one or more configurations of game symbols, one or more of the configurations of game symbols being associated with a winning game outcome, the winning game outcome being associated with a value award payable to a player; and
pay the first value award to the player in response to a trigger event occurring in a play of the second game.

A further embodiment provides a computer system comprising a central processing unit configured for communication with a gaming machine, wherein the computer system is configured to perform the method of any one of the above described embodiments of the present disclosure.

A further embodiment provides a computer program configured to perform the method of any one of the above described embodiments of the present disclosure.

A further embodiment provides a non-transitory carrier medium carrying computer executable code that, when executed on a central processing unit configured for communication with a gaming machine, causes the central processing unit to perform the method of any one of the above described embodiments of the present disclosure.

Throughout the specification and unless explicitly stated otherwise, the term “value” means credits, gaming tokens, coins, paper, currency, tickets, vouchers, credit cards, debit cards, smart cards, memory devices capable of storing value and any other object representative of value.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### BRIEF DESCRIPTION OF THE DRAWINGS

The disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings is necessarily to scale.

FIG. 1 is a perspective view of a gaming machine according to a first embodiment of the present disclosure.

FIG. 2 is a schematic drawing of an electronic controller for the gaming machine of FIG. 1.

FIG. 3 is a simulated screen shot of a base game shown on the display of the gaming machine of FIG. 1.

FIGS. 4A to 4E are exemplary multiplier tables that may be used for the base game shown in FIG. 3.

FIG. 5 is a simulated screen shot of a feature game shown on the display of the gaming machine of FIG. 1.

FIGS. 6 to 8 are simulated screen shots of another feature game shown on the display of the gaming machine of FIG. 1.

FIG. 9 is a simulated screen shot of a further feature game shown on the display of the gaming machine of FIG. 1.

FIGS. 10 to 14 are partial simulated screen shots of another base game shown on the display of the gaming machine of FIG. 1.

FIGS. 15 and 16 are partial simulated screen shots of yet another feature game shown on the display of the gaming machine of FIG. 1.

FIG. 17 is an exemplary multiplier table that may be used for the feature game of FIGS. 15 and 16, and may be shown on the display of the gaming machine of FIG. 1.

FIG. 18 is a perspective view of an electronic gaming machine according to yet another embodiment of the present disclosure.

FIG. 19 is a schematic drawing of a control panel for the electronic gaming machine of FIG. 18.

FIG. 20 is a block diagram of the electronic components of the electronic gaming machine of FIG. 18.

### DETAILED DESCRIPTION OF VARIOUS EMBODIMENTS

The present disclosure will now be described with reference to the following examples which should be considered in all respects as illustrative and non-restrictive. In the Figures, corresponding features within the same embodiment or common to different embodiments have been given the same reference numerals.

In general terms, a gaming machine according to the embodiments described herein includes at least one display, and an electronic controller coupled to the at least one display. In some embodiments, the gaming machine is configured to receive a wager from a player. In other embodiments, the gaming machine comprises a value transfer mechanism or a value input that is coupled to the electronic controller.

The electronic controller is configured to display a first game on the display including one or more configurations of game symbols, one or more of the configurations of game symbols being associated with a winning game outcome, the winning game outcome being associated with a value award payable to a player. In one embodiment, the electronic controller is also configured to select a multiplier, calculate a bonus prize value award from the multiplier and the wager, associate the bonus prize value award payable to the player with a trigger event and pay the bonus prize value award in response to the trigger event occurring in the first game.

In some embodiments, wherein the trigger event comprises the appearance of one or more special symbols on the display. In other embodiments, as the number of the special symbols increases the probability of awarding a multiplier with a higher amount increases.

In some embodiments, the trigger event comprises the appearance of a first configuration of game symbols on the display.

In some embodiments, there are a predetermined number of plays in the first game and the bonus prize value award is paid to the player each time the trigger event occurs in the predetermined number of plays of the first game.

In some embodiments, the electronic controller applies the selected multiplier to the wager to calculate bonus prize value award.

In some embodiments, the electronic controller selects the multiplier from a predefined range of multipliers.

In some embodiments, the electronic controller randomly selects the multiplier from a range of multipliers, each multiplier having an associated probability of selection, the associated selection probabilities between at least two multipliers being different. Preferably, there is a plurality of the multiplier ranges, the electronic controller selecting one of multiplier ranges based on the amount of the wager and then selecting the multiplier from the selected multiplier range. Alternatively, the trigger event comprises the appearance of one or more special symbols on the display and there is a plurality of the multiplier ranges, the electronic controller selecting one of multiplier ranges based on the number of special symbols that have appeared on the display.

In some embodiments, the electronic controller selects the multiplier from a range of multipliers based on a total number of special symbols that have appeared in the first game. Preferably, each multiplier in the range of multipliers is associated with a threshold number of the special symbols, the electronic controller determines the total number of special symbols and the electronic controller selects the multiplier from the range corresponding to the threshold number that is less than or equal to the total number of special symbols.

In some embodiments, the wager comprises at least one of a bet option, bet per pay line, total number of pay lines, bet per set of ways and a total bet.

In some embodiments, the electronic controller is further configured to:

provide an array of game positions in which to display the one or more configurations of game symbols; and

provide the array with one or more non-game symbol positions in which only a non-game symbol can be displayed, the non-game symbol being a symbol that does not form part of any of the one or more configurations of game symbols and wherein there are different types of non-game symbols that are randomly selected for display in the one or more non-game symbol positions;

wherein the trigger event comprises the appearance of a special symbol in the at least one of the non-game symbol positions.

In another embodiment, the electronic controller is also configured to select a multiplier, calculate a bonus prize value award from the multiplier and the wager, display a second game in response to the first trigger event occurring in the first game, associate the bonus prize value award with a second trigger event in the second game and pay the bonus prize value award in response to the second trigger event occurring in the second game.

In some embodiments, the first trigger event comprises the appearance of two or more scatter symbols and the electronic controller randomly selects the multiplier from a range of multipliers, each multiplier having an associated probability of selection, the associated selection probabilities for higher multipliers being greater as the number of the scatter symbols increases.

In some embodiments, the second trigger event comprises the appearance of one or more special symbols on the display.

In some embodiments, there are a predetermined number of plays in the second game and the bonus prize value award is paid to the player each time the trigger event occurs in the predetermined number of plays of the second game.

In some embodiments, the electronic controller selects the multiplier from a range of multipliers, each multiplier having an associated probability of selection, the associated selection probabilities between at least two multipliers being different. Preferably, there is a plurality of the multiplier ranges, the electronic controller selecting one of multiplier ranges based on the amount of the wager and then selecting the multiplier from the selected multiplier range.

In some embodiments, the electronic controller selects the multiplier from a range of multipliers based on a total of special symbols that have appeared in the first game. Preferably, each multiplier in the range of multipliers is associated with a threshold number of the special symbols, the electronic controller determines the total number of special symbols and the electronic controller selects the multiplier from the range corresponding to the threshold number that is less than or equal to the total number of special symbols.

In some embodiments, the bonus prize value award is paid to the player in response the first trigger event.

In some embodiments, the first game comprises a base game and the second game comprises a feature game.

In a further embodiment, the electronic controller is also configured to associate a first configuration of game symbols appearing on the display with a first winning game outcome, the first winning game outcome being associated with a first value award payable to the player.

In a yet further embodiment, the electronic controller is further configured to associate the first value award with a trigger event when the first configuration of game symbols appears in a play of the first game; and pay the first value award to the player in response to the trigger event occurring in a subsequent play of the first game.

In a still further embodiment, the electronic controller is further configured to pay the first value award to the player and display a second game on the display in response to a first configuration of game symbols appearing in the first game. The second game is different to the first game and includes one or more configurations of game symbols, one or more of the configurations of game symbols being associated with a winning game outcome, the winning game outcome being associated with a value award payable to a player. The electronic controller is moreover configured to pay the first value award to the player in response to a trigger event occurring in a play of the second game.

In some embodiments, the trigger event comprises the appearance of a second configuration of game symbols on the display. In one embodiment, the second configuration of game symbols on the display comprises two or more of the same game symbols.

In some embodiments, there are a predetermined number of plays in the first game and the first value award is paid to the player each time the trigger event occurs in the predetermined number of plays of the first game.

In some embodiments, the first value award payable upon occurrence of the trigger event is increased by a multiplier. In one embodiment, the multiplier is determined at the start of the first game. In another embodiment, the multiplier is determined during play of the first game prior to the trigger event.

In some embodiments, the first game comprises a feature game.

In some embodiments, the electronic controller is further configured to:

provide an array of game positions in which to display the one or more configurations of game symbols; and

provide the array with at least one non-game symbol position in which only a non-game symbol can be displayed, the non-game symbol being a symbol that does not form part of any of the one or more configurations of game symbols;

wherein the trigger event comprises the appearance of a special symbol in the at least one non-game symbol position.

In some embodiments, the trigger event comprises the appearance of the special symbol in the at least one non-game symbol position and at least one of the configurations of game symbols associated with a winning game outcome.

In some embodiments, the display of the non-game symbol and at least one of the configurations of game symbols associated with a winning game outcome causes the electronic game controller to enhance the prize awarded for the winning game outcome.

In some embodiments, the non-game symbol comprises at least one of a bonus symbol that increases the prize awarded for the winning game outcome; a multiplier symbol that multiplies the prize awarded by an amount associated with the multiplier symbol; a free games symbol that awards additional plays of the game without requiring a bet from the player; a blank symbol that does not enhance the award of prizes; and a credit bonus symbol that increases the prize awarded by an amount associated with the credit bonus symbol.

In some embodiments, the at least one non-game symbol position comprises a reel that randomly displays the non-game symbols.

In some embodiments, there are two or more non-game symbol positions in the array that each randomly displays one of the non-game symbols for each play of the first game.

In some embodiments, there are different types of non-game symbols and there are two or more non-game symbol positions in the array that each displays a randomly selected non-game symbol from the different types of non-game symbols for each play of the first game

In some embodiments, the non-game symbol positions are aligned in the array.

In some embodiments, the game positions and non-game symbol positions are arranged into a plurality of rows and/or columns, the non-game symbol positions being arranged in the same column. In one embodiment, the columns that do not have the non-game symbol positions comprise reels. In another embodiment, the array comprises three rows and five columns, the non-game symbol positions being located in a top and a bottom row of a middle column.

In further embodiments, the first trigger event comprises a first configuration of game symbols appearing on the display is associated with a first winning game outcome, the first winning game outcome being associated with the first value award. In one embodiment, the first configuration comprises a combination of two or more scatter symbols.

In further embodiments, the second trigger event comprises the appearance of one or more special symbols on the display

In other embodiments, there are a predetermined number of plays in the second game and the first value award is paid to the player each time the trigger event occurs in the predetermined number of plays of the second game.

In other embodiments, the first game comprises a base game and the second game comprises a feature game. In one embodiment, the first configuration of game symbols comprises a combination of two or more scatter symbols.

In other embodiments, there are two or more non-game symbol positions in the array that each randomly displays one of the non-game symbols for each play of the second game.

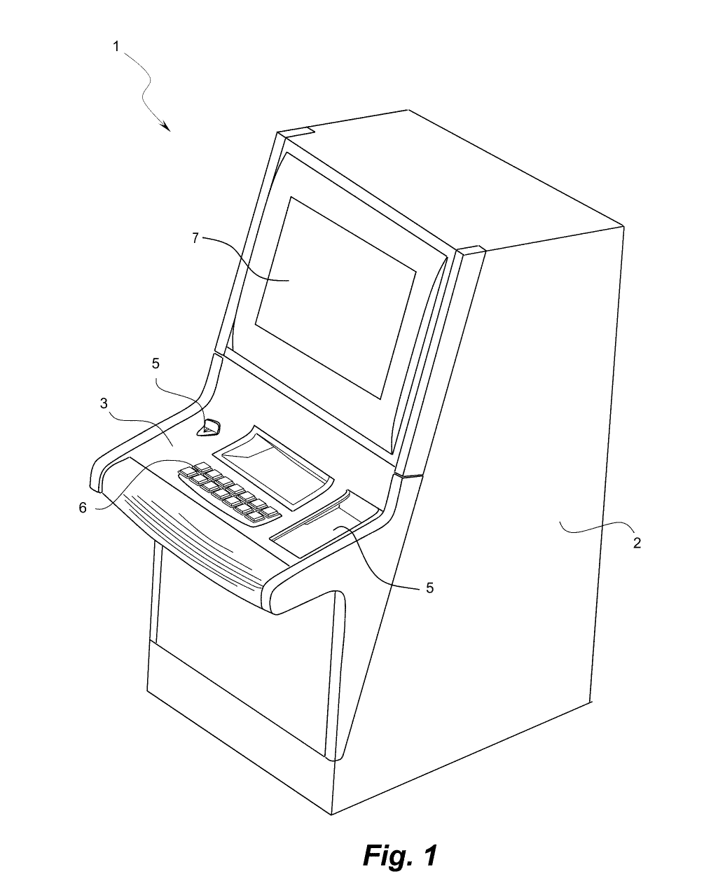

Referring to FIG. 1, a gaming machine 1 according to a first embodiment includes a cabinet 2, a console 3 and an internal electronic controller 4. The console 3 has various input devices including value inputs, such as vending slots 5 for receiving monetary bets, and a plurality of buttons 6 for actuation by a player. It will be appreciated that in other embodiments the vending slots 5 may be replaced with other types of value input/value output devices, such as a coin acceptor, a paper currency acceptor, a ticket reader and/or printer or a card reader and/or writer.

The vending slots 5 can be configured to receive value, such as cash in the form of banknotes and coins, or credits representing a monetary amount from a memory device, such as but not limited to a memory card, smart card, a radio frequency identification (RFID) device, USB key, magnetic card or other electronic storage device. Typically, the memory device is a credit card, debit card or other card that enables the transfer of monetary credit to the gaming machine 1. Other forms of value include gaming tokens, paper, tickets, vouchers, and any other object representative of value.

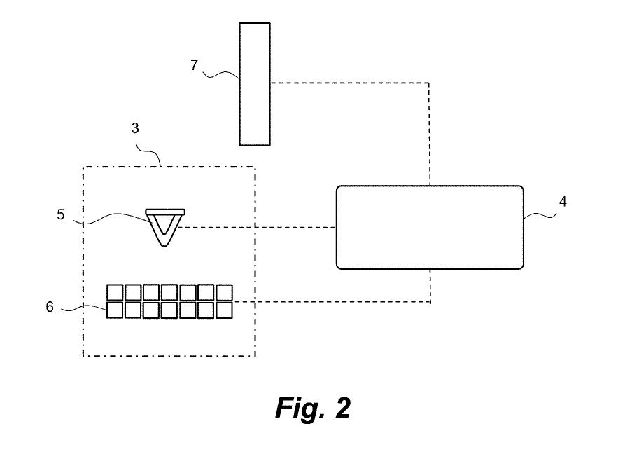

The electronic controller 4 is generally in the form of an electronic game controller comprising a central processing unit, such as a computer, and is in electronic communication with a display in the form of a video display screen 7, as well as various input devices on the console 3, as best shown in FIG. 2. Typically, the electronic game controller 4 also comprises a random access memory (RAM) associated with the central processing unit, the RAM being used to store programme instructions and transient data related to the operation of the electronic game controller and hence the gaming machine 1. The RAM contains a body of program instructions for implementing a game on the gaming machine 1, as discussed in more detail below. The central processing unit or processor may also be operatively associated with a further storage device, such as a hard disk drive, which is used for long-term storage of program components and data relating to the electronic game controller 4 and/or the gaming machine 1, including a database for game performance data, as well as information gathered from users. It is also appreciated that a person skilled in the art would readily understand the location and use of the electronic game controller 4 in the gaming machine 1.

The electronic game controller 4 will transmit and receive signals to and from each of the input devices and the display 7, usually via wired connections but can include wireless modes of electronic communication, such as WLAN. In the case of the vending slots 5 (or with any other type of value transfer mechanism), there may be an intermediate credit verification device that examines and verifies the cash or credits received by the vending slots. Once the value (such as cash or credits) have been verified by the credit verification device, a signal is sent to the electronic game controller 4, which then determines whether the minimum bet level has been reached. If so, the electronic game controller 4 will permits play of the game on the gaming machine 1. If not, the electronic game controller 4 will send a signal to the display 7 to show a message requesting further value to be added to the gaming machine 1.

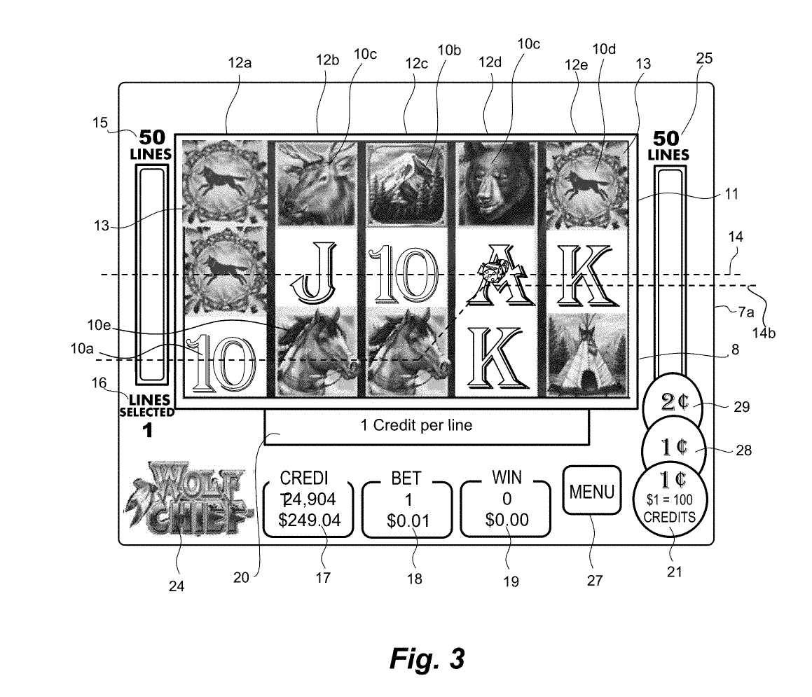

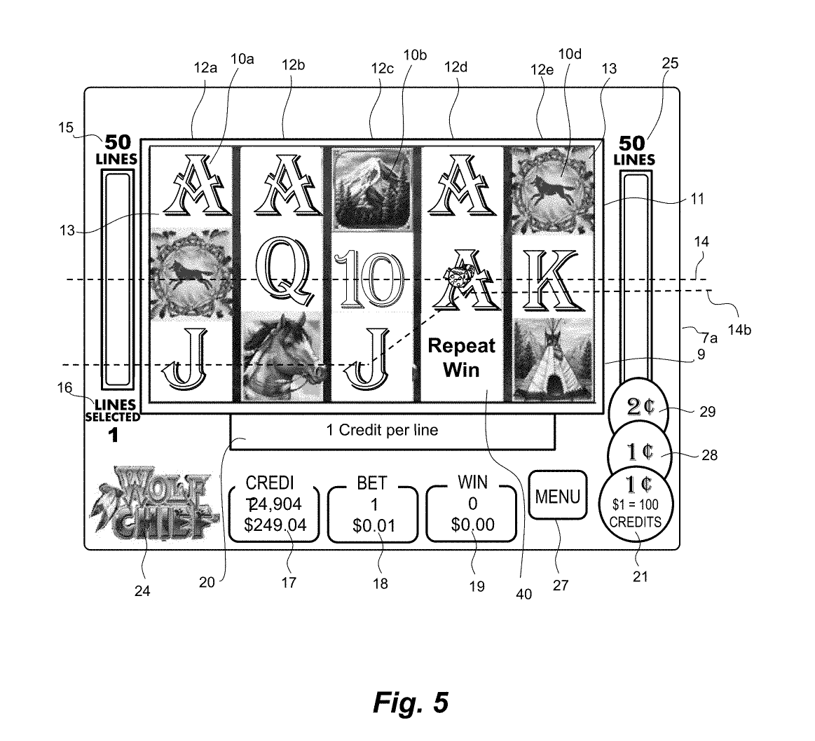

The electronic game controller 4 is programmed to provide a game in the form of a base game 8 (as best shown in FIG. 3) and a feature game 9 (as best shown in FIG. 5) on a lower playing area 7a of the display 7 of the gaming machine 1 for play by a player. An upper display area (not shown) is reserved for showing artwork associated with the game(s) that are available for play on the gaming machine and/or other game information. The base game 8 has game symbols 10 arranged into an array 11 in the form of five columns or “reels” 12. The reels 12 give the visual appearance of rotating, typically by having the game symbols 10 move in a downward linear path along the length of each reel 12. While the array 11 is arranged with five reels 12 and three rows as per the industry standard, it will be appreciated by one skilled in the art that other types of arrays could be used, such as 3×3, 4×3, 5×5, 4×4, etc., including arrays having an irregular number of rows and/or columns. For example, the array 11 can have an unequal number of rows and/or columns, where some columns have less or more rows than other columns or where some rows have less or more columns than other rows. A more specific example would be an array having three columns with only two rows and two columns with three rows. The electronic game controller 4 will transmit signals to the display screen 7 to cause the base game 8 and feature game 9 to be played on the lower playing area 7a, including showing the game symbols 10, array 11 and other visible elements of the games.

The array 11 of the base game 8 defines predetermined game or symbol positions 13, in which the game symbols 10 appear. The symbol positions 13 are not visually marked by boundary lines and simply provide an area for the game symbols 10 to appear. However, it will be appreciated that in other embodiments, the symbol positions 13 are defined by visible boundary lines (to define “squares” or game positions) or other markings to define each respective area of the symbol positions.

The array 11 is arranged so that a player can select one or more predetermined “pay lines” 14 defined around the array, which correspond to combinations of the symbol or game positions 13. The pay lines 14 correspond to the lines selected by the player and generally comprise at least one game position or symbol position 13 from each reel 12. The number of pay lines 14 that can be selected by the player depends on the amount of the monetary bet for playing a game on the array 11. In the base game 8, predetermined winning combinations of randomly selected game symbols 10 result in the award of prizes to the player.

The game symbols 10 can include a mixture of picture symbols (such as animal symbols or playing card symbols), word symbols, scatter symbols, substitute or wild card symbols and trigger symbols to trigger the feature game 9. Those skilled in the art will readily understand that a substitute symbol is able to act as any other game symbol, and hence is also known as a “wild card” symbol. Likewise, those skilled in the art will readily understand that a scatter symbol is a symbol that triggers a game event or confers an award without having to appear on a player-selected pay line 14. Similarly, a trigger symbol is a symbol that triggers a game event or confers an award, where the trigger symbol may or may not have to appear in combination and may or may not have to appear on the same player-selected pay line 14. In this embodiment, the game symbols 10 include playing card symbols 10a, animal-themed symbols 10b, item-themed symbols 10c, scatter symbols in the form of “wolf banner” symbols 10d and a substitute or wild card symbol in the form of horse symbols 10e. The electronic game controller 4 randomly determines the appearance of the game symbols 10 on the array 11.

The video screen 7 also displays other standard game information in the lower playing area 7a, including the number of pay lines available 15, the number of player-selected pay lines 16, the amount of player credits 17, the amount of the current bet wagered by the player 18, the amount of wins by the player 19, a message area 20, a current denomination button 21 indicating the currently selected base bet denomination and the name 24 of the base game 8, Wolf Chief™, as best shown in FIG. 3. In other embodiments, the video screen 7 displays a menu button for bringing up a menu screen (typically explaining the game rules and showing the available pay lines 14) and/or jackpot information relating to the based game 8 and feature game 9 that are awarded by the electronic gaming machine 1. This jackpot information is typically displayed in the upper display area and can comprise, in descending order of monetary value, a grand jackpot, major jackpot, minor jackpot and mini jackpot.

In the base game 8, the player initially makes a bet using vending slots 5 to initiate play of the gaming machine 1 by building up credit to play the base game 8 on the gaming machine. For example, the player can bet or wager monetary amounts equivalent to a particular amount of credits, depending on the bet denomination selected for the base game. Also, the player can make any additional side bets or ante-bets during play of the base game 8 once the base game has commenced to access additional features in the base game, such as increasing the number of winning combinations in the base game.

Typically, gaming machines offer a number of preset bet options that the player can make, and these bet options can vary depending on the game or games offered on the gaming machine. For example, a game on a gaming machine may provide bet options of 1 credit, 2 credits, 5 credits and 10 credits per player-selected pay line 14. In another example, the player may bet 1 credit, 2 credits, 5 credits and 10 credits for a preset group or combination of pay lines 14, such as a group of 5 pay lines, 10 pay lines, 20 pay lines, etc.

The gaming machine 1 also has a default bet denomination, which is usually the bet denomination that was previously used in the preceding play of the base game 8. For example, if a person had played the base game 8 with a bet denomination of 5¢, then this would be the default bet denomination for the player when he or she commences play of the game. Where the gaming machine has not yet been played or has been started up, the default bet denomination is initially selected by the electronic game controller 4. The default bet denomination can be randomly selected or chosen according to a predetermined order. Usually, the electronic game controller 4 will select the bet denomination with the lowest value that is available for the base game 8, which would be the 1¢ bet denomination for this embodiment. The player may change the bet denomination at any time in the base game 8 by touching the denomination button 21 before or after the reels 12 have spun. In this embodiment, touching the denomination button will bring denomination images 28, 29 that the player may select to quickly change the bet denomination between plays of the game 8.

Once the player has commenced play of the game 8 by making an appropriate bet via the vending slots 5, the electronic game controller 4 then commences a play of the base game 8 by sending a signal to the display 7 to cause the reels 12 to appear to visibly rotate or “spin” in a linear path, typically in a downward vertical direction, and randomly display the game symbols 10 in each game position for each play of the array 11 for the base game 8. After the reels 12 stop spinning (and thus ends the spin or play of the base game 8), the electronic game controller 4 determines whether there are any predetermined winning combinations of the game symbols 10 appearing in any player-selected pay lines 14, such as a two of a kind, three of a kind, four of a kind or five of a kind for all the game symbols 10 and other combinations of a “full house”, “straight” or “flush” for the playing card game symbols 10a. It will be appreciated that other winning combinations of game symbols 10 can also be provided. If so, the gaming machine 1 enters a winning game state and awards a prize according to the displayed predetermined winning combination.

The electronic game controller 4 also determines whether the feature game 9 should be activated, based on a predetermined feature game trigger event, such as the appearance of a number of trigger symbols appearing in a play or spin of the base game 8. In this embodiment, the feature game trigger event is the appearance of three scatter symbols 10d. The scatter symbols 10d need not appear on the same pay line 14, but can appear on any of the player-selected pay lines. As shown in FIG. 3, the player is awarded a prize for the appearance of the three scatter symbols 10d, as well as a prize the combination of symbols shown in pay line 14b comprising the Ace symbol 10a and two substitute horse symbols 10e, resulting in a three of a kind. In this embodiment, the “scatter” prize for the scatter symbols 10d is calculated from the bet option selected by the player to play the base game 8 times a multiplier randomly selected by the electronic game controller 4.

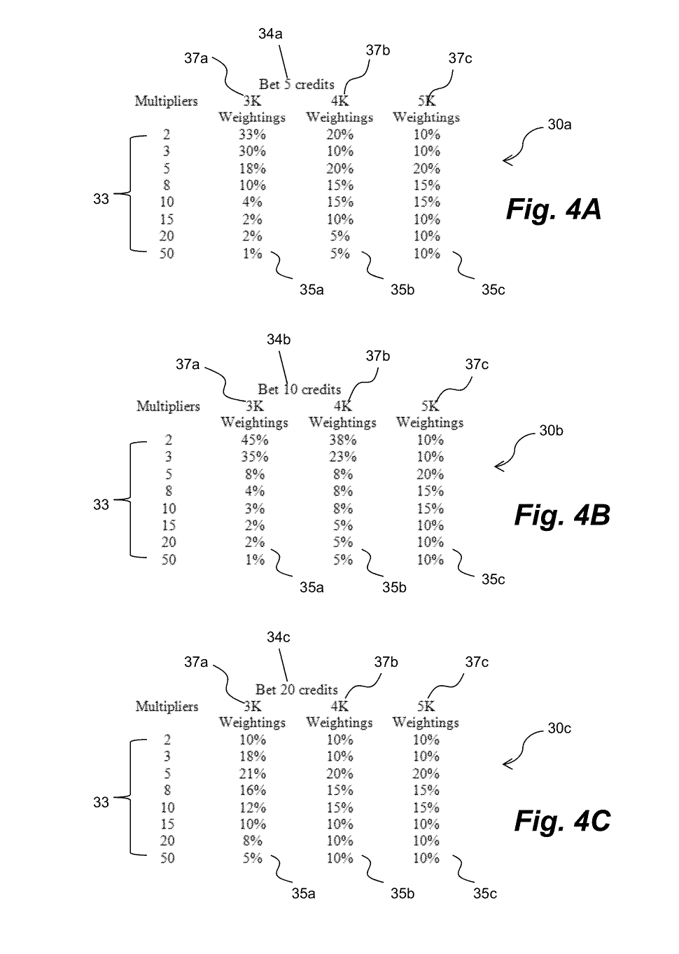

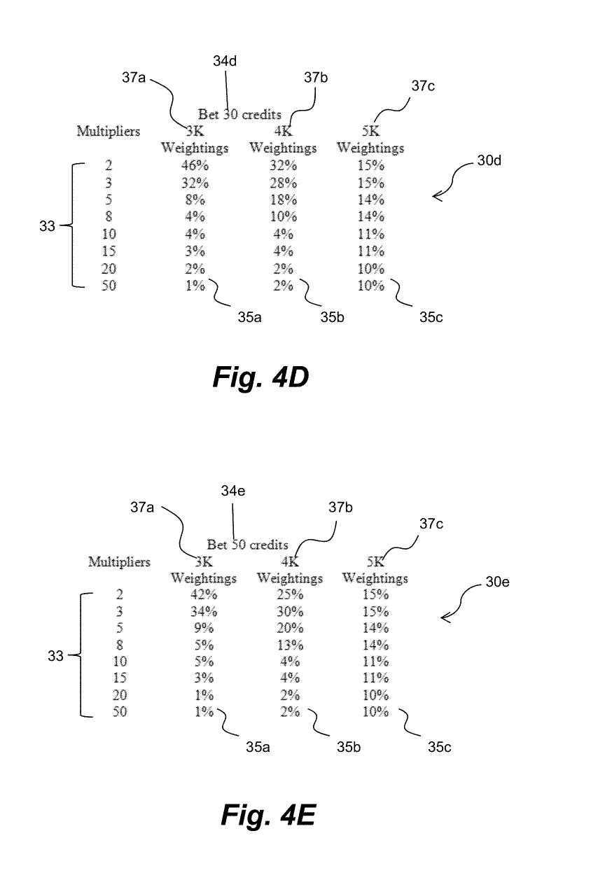

The multipliers are randomly selected from a predefined range of ×2 up to ×50 based on a weighted probability that depends on the number of scatter symbols and the bet option. Referring to FIGS. 4A to 4E, multiplier tables 30a to 30e are referred to by the electronic game controller 4 to select the multiplier 33 to the applied to the bet option 34 and thus calculate the scatter prize. For example, in FIG. 4A the multiplier table 30a lists the probabilities for each multiplier in columns 35a, 35b, 35c depending on whether three, four or five scatter symbols 10d have appeared, as indicated by the column headings 3K (three of a kind) 37a, 4K (four of a kind) 37b and 5K (five of a kind) 37c. The electronic game controller 4 selects the multiplier table 30a to 30e based on the bet option 34a to 34e wagered. In the case of FIGS. 4A to 4E, the multiplier table 30a is used where the bet option chosen by the player is 5 credits; the multiplier table 30b is used where the bet option chosen by the player is 10 credits; the multiplier table 30c is used where the bet option chosen by the player is 20 credits; the multiplier table 30d is used where the bet option chosen by the player is 30 credits; and the multiplier table 30e is used where the bet option chosen by the player is 50 credits. As can be seen by a comparison of the multiplier tables 30a to 30e, the weighted probabilities generally increase for the higher multipliers like, ×10, ×15, ×20 and ×50 as the bet option increases. Also, the weighted probabilities generally increase for the higher multipliers like ×10, ×15, ×20 and ×50 as the number of scatter symbols 10d appearing on the reels 12 increase. Referring back to FIG. 3, assuming that the bet option of 5 credits was chosen, then the electronic game controller 4 would refer to the 3K column 33b to randomly select a multiplier for applying to the amount of 5 credits. In this case, there would be a 33% chance of the ×2 multiplier being selected, which would result in a scatter prize of 10 credits being awarded. This scatter prize amount is recorded and stored by the electronic game controller 4 for use in the feature game 9, as described in more detail below.

In response to the trigger event, the electronic game controller 4 then transmits a signal to the video screen 7 to cause the feature game 9 to appear on the video screen 7, as best shown in FIG. 5. The feature game 9 uses the same game symbols 10 as the base game 8, as well as the same array 11, reels 12, game positions 13 and player-selectable pay lines 14 on the video screen 7. In the feature game 9, ten free plays or spins of the feature game are awarded to the player without having to make an additional bet or wager. It will be understood by those skilled in the art that a free play or spin involves a play of the game without requiring any bet to be made by the player, and that any number of free spins can be chosen for the feature game 9. In addition, it will be appreciated that in the art free spins are commonly referred to as “free games”. The number of free games remaining in the feature game 9 is indicated by a counter 51. Typically, the prizes awarded for the same winning combinations of game symbols in the feature game 9 are of higher value than the prizes awarded in the base game 8.

The feature game 9 operates in a similar manner to the base game 8, where the reels 12 visibly rotate and display randomly selected game symbols 10 in each game position 13, as best shown in FIG. 5. Predetermined winning combinations of randomly selected game symbols 10 in the array of the feature game 9 also result in the award of prizes to the player, usually of an enhanced value compared to the prizes awarded in the base game 8. In addition, where a “Repeat Win” symbol 40 appears in the reels 12a to 12e, the electronic game controller 4 also awards the scatter prize that was calculated and stored when the feature game 9 was triggered. In FIG. 5, the Repeat Win symbol 40 has appeared in the reel 12d and so the player is awarded the scatter prize of 10 credits (being the scatter prize that was determined when the feature game was triggered).

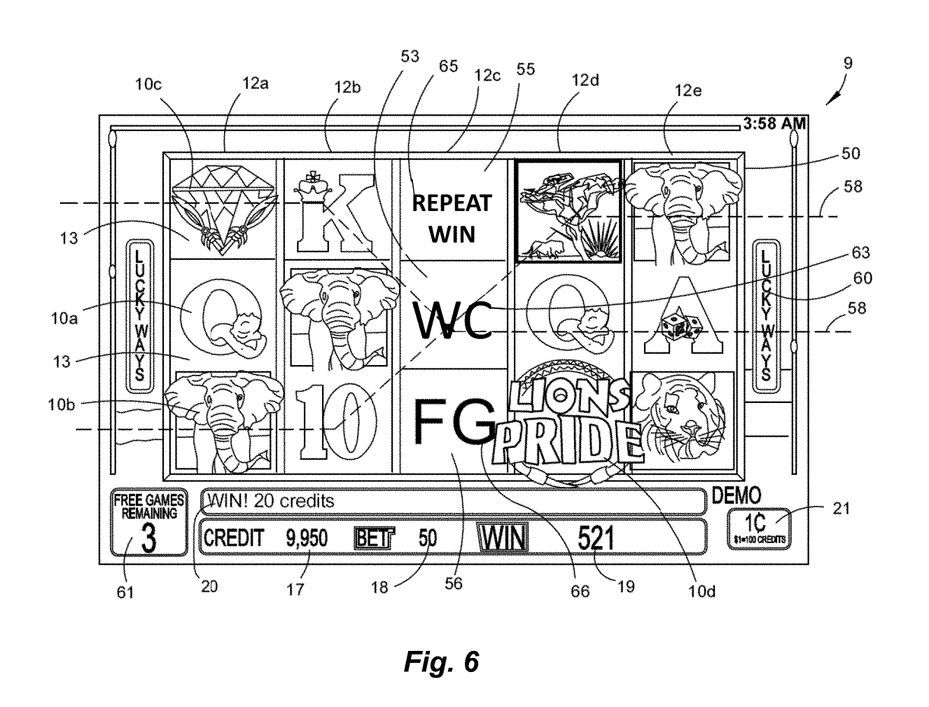

Referring to FIGS. 6 to 8, another embodiment is illustrated where the feature game 9 comprises an array 50 that corresponds to the array 50 described in U.S. patent application Ser. No. 15/219,001, which application is hereby incorporated by reference in its entirety. The array 50 comprises three rows and five columns, the columns 12a, 12b, 12d and 12e comprising reels displaying game symbols in game positions 13, whereas column 12c comprises a single game position 53 and two non-game symbol positions 55, 56 for displaying one or more non-game symbols, which is described in more detail below. The non-game symbol positions 55, 56 also act as independent reels in this embodiment and so will be described as non-game reels. However, in other embodiments, the non-game symbol positions 55, 56 could be parts of one reel, such as where the non-game symbol positions are located adjacent each other to form a single reel.

The feature game 9 uses the same reels 12a, 12b, 12d and 12e and their respective game positions 13, while game symbols 10 are similar to the game symbols of the base game 8 of FIG. 3 but have an African safari theme. However, the pay lines 58 are altered to use only the game position 53 of column 12c. The non-game symbol positions 55, 56 are not used in any pay lines 58 and thus do not form part of any combinations of game symbols 10 used to award prizes in the feature game 9. Thus, the feature game array 50 comprises a 3×3×1×3×3 column configuration that is non-standard in operation compared to typical regular rectangular or square arrays that are 5×3 or 3×3 in configuration. However, in appearance the feature game array 50 looks like a standard 5×3 array but in fact has two integrated non-game reels 55, 56. In effect, the feature game 9 provides 81 “ways” (corresponding to pay lines 58) in which a winning combination of game symbols 10 may be obtained on the array 50. In this embodiment, the player will select a bet option that give the player a predefined number of “ways” (for example, 9, 27 and 81 ways) that are available or active on the array 50. In addition, the feature game array 50 includes a “theme” name 60 of “Lucky Ways” indicating the type of feature game 9 that is being played on the video screen 7.

In the feature game 9, a number of free games of the feature game are awarded to the player without having to make an additional bet or wager. The number of free games remaining in the feature game 9 is indicated by a free games counter 61, which shows that four free games were initially awarded since three free games remain as indicated by the counter 61. Typically, the prizes awarded for the same winning combinations of game symbols in the feature game 9 are of higher value than the prizes awarded in the base game 8.

The feature game 9 operates in a similar manner to the base game 8 of FIG. 3, where the reels 12a, 12b, 12d and 12e visibly rotate and display randomly selected game symbols 10 in each game position 13, as best shown in FIG. 6. At the same time, the non-game reels 55, 56 visibly rotate or “spin” to reveal a non-game symbol or a “blank” symbol, while game position 53 shows a wild card symbol 63. Since all the pay lines 58 of the feature game array 50 pass through the game position 53, all possible combinations on each pay line will include at least one substitute or wild card symbol (being the wild card symbol 63).

In this embodiment, the non-game symbols include a Repeat Win symbol 65 and a free games FG symbol 66. The Repeat Win symbol 65 awards a prize previously won by the player in the base game 8 upon triggering the feature game 9 increased by a randomly selected multiplier. This multiplier may be indicated by a separate multiplier meter (not shown). In this case, the prize is the prize that was won by the player when the feature game 9 was triggered (i.e. the scatter prize of 10 credits). The FG symbol 66 awards additional free games or spins of the feature game that are added to the free games counter 61. In FIG. 6, the non-game reel 55 shows a Repeat Win symbol 65 that awards a prize of 10 credits (being the scatter prize won when the feature game 9), while the non-game reel 56 shows an FG symbol 66 that awards three free spins of the feature game, which would increase the free games counter from 3 to 6. The prize awarded by the Repeat Win symbol 65 is in addition to any other prizes won by the player from winning combination of game symbols 10 shown in the array 50.

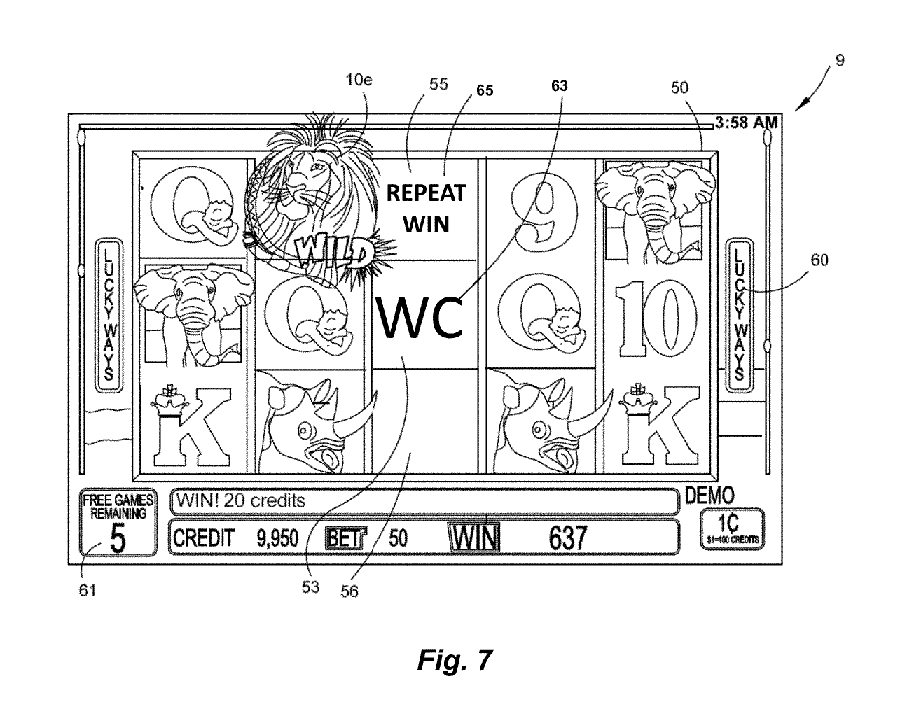

In the next free spin, as shown in FIG. 7, the non-game reel 55 shows an Repeat Win symbol 65 to award the player the same scatter prize of 10 credits. The presently remaining five free games are shown in the free games counter 61. However, the non-game reel 56 shows a “blank”, meaning that nothing has been awarded by this reel. The blank can simply be an empty game position 56 as shown in FIG. 7 or a specific blank symbol can be shown.

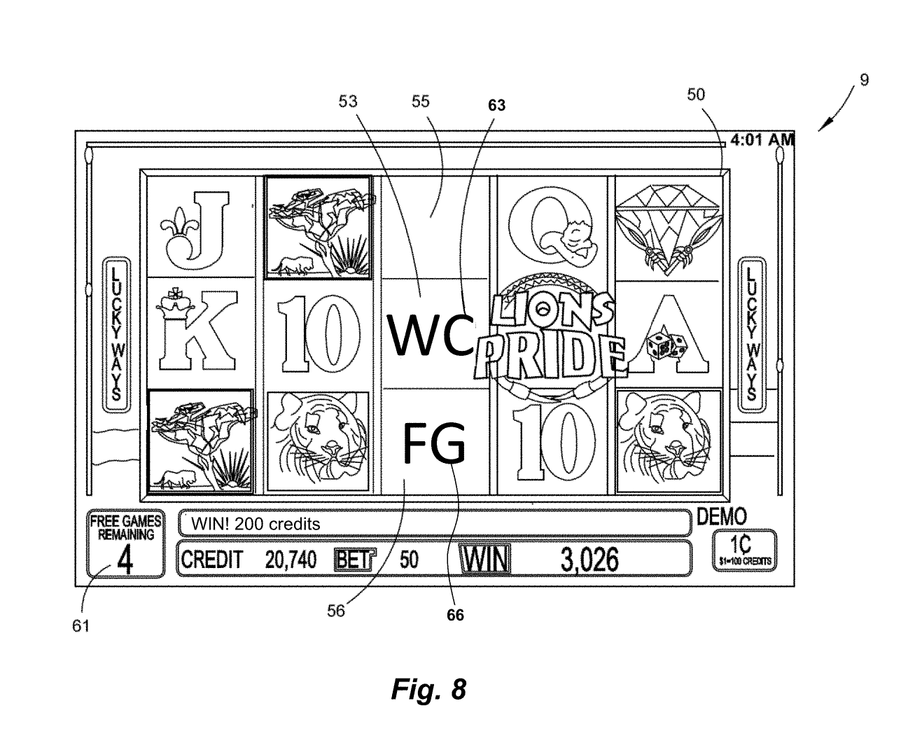

The following free spin is shown in FIG. 8, and the non-game reel 55 shows a blank, whereas the non-game reel 56 shows a FG symbol 66 additional free games to presently remaining four free games shown in the free games counter 61. Since the Repeat Win symbol 65 does not appear in either of the non-game reels 55, 56, the scatter prize is not awarded. Hence, the amount of 10 credits is awarded each time the Repeat Win symbol 65 appears in the non-game reels 55, 56

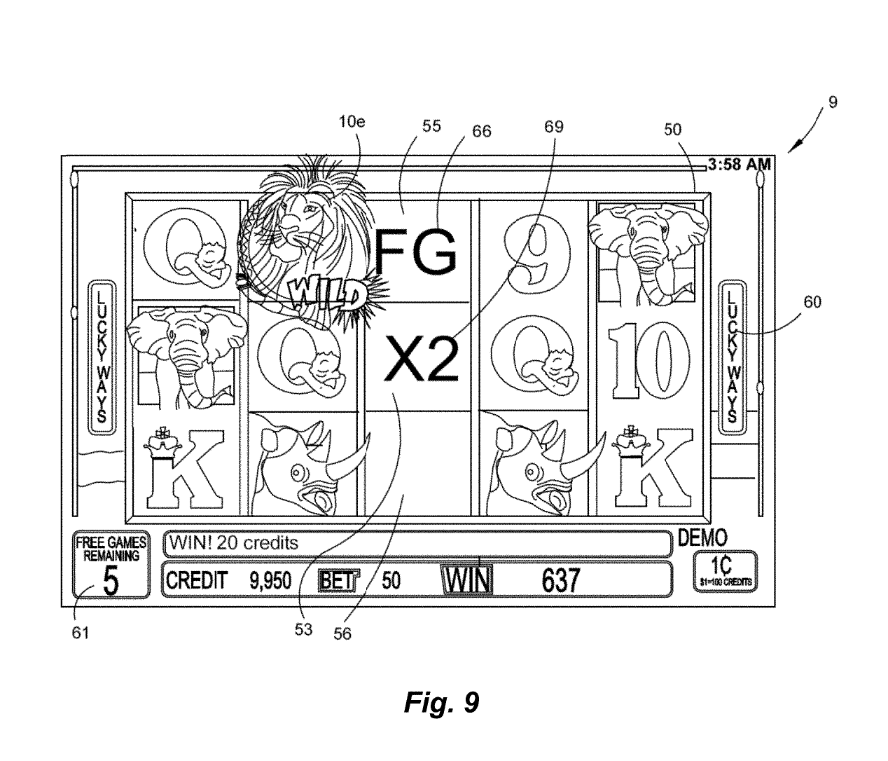

In another embodiment shown in FIG. 9, the wild card symbol 63 is replaced with a wild multiplier symbol 69. In this case, the scatter prize previously won by the player in the base game 8 upon triggering the feature game 9 increased by a randomly selected multiplier, such as drawn from a multiplier table similar to one of the multiplier tables 30a to 30e. Therefore, the multiplier table may provide a weighting of each multiplier based on the bet option 34a to 34e. This multiplier may be indicated by the amount shown by the wild multiplier symbol 69 or by a separate multiplier meter (not shown). In this case, the prize is the prize that was won by the player when the feature game 9 was triggered (i.e. the scatter prize of 10 credits), which is multiplied by the amount indicated by the wild multiplier symbol 69. In FIG. 9, the wild multiplier symbol 69 is ×2, so the scatter prize is increased to 20 credits. The ×2 wild multiplier symbol 69 is also applied to any winning combinations of game symbols 10 appearing on the reel array 50. In a further embodiment, a multiplier is predetermined in the base game and is applied to the bet made by the player in order to calculate the scatter prize or prize associated with the feature game trigger event. Hence, the multiplier is in-built into the amount of the trigger win (such as the scatter prize) that is subsequently awarded by the Repeat Win symbol 65. Yet another embodiment uses a multiplier selected (randomly or in a predetermined order) prior to commencement or during play of the feature game 9.

In some embodiments, the Repeat Win symbol 65 awards the total prize previously won by the player in the base game 8 upon triggering the feature game 9 increased by the randomly selected multiplier. In this case, the total prize includes both the prize associated with the feature game trigger event (i.e. the scatter prize) and any prizes that were won at the same time. In other embodiments, only the prize(s) awarded for winning combinations of game symbols 10 are associated with the Repeat Win symbol 65. In further other embodiments, only one prize of the prizes awarded for winning combinations of game symbols 10 is associated with the Repeat Win symbol 65. In this case, this would be the prize having the highest worth. Thus, there is not a cumulative prize awarded in these embodiments.

Also, where the Repeat Win symbol 65 is shown more than once by appearing in both the non-game reels 55, 56 for the same spin, the prize is won twice. That is, the scatter prize won when the feature game 9 was triggered is paid twice as there are two occurrences of the Repeat Win symbol 65. This increases the probability of winning prizes of higher worth. In other embodiments, the prize awarded by the Repeat Win symbol 65 may only be won once per spin of the reels 12a, 12b, 12d, 12e and non-game reels 55, 56. In further embodiments, the associated scatter prize is only awarded for a maximum number of times in the same spin. For example, the scatter prize is limited to being awarded five times in any one spin so that where six Repeat Win symbols 65 appear, the scatter prize is only awarded five times and a scatter prize for the sixth Repeat Win symbol 65 is not awarded.

Also, in some embodiments, the prize associated with the Repeat Win symbol 65 need not be a scatter prize but can be simply a predefined prize determined by the multiplier tables 30a to 30e and the bet option 34a to 34e, where there is a set weighting for each table; i.e. there is only one column of weighted probabilities for each multiplier.

In a further embodiment, the feature game trigger event may not be the appearance of three scatter symbols, but may be any combination of a designated trigger symbol or combination of designated trigger symbols. Hence, a specific combination of game symbols could be designated as special trigger symbols, such as four Ace symbols, with its prize in the paytable being associated with the Repeat Win symbol 65.

In some embodiments, a multiplier symbol (not shown) may also appear in the non-game reels 55, 56 to increase the amount of the multiplier shown by the multiplier symbol 69. The increase may be by a uniform increments (for example, increments of one so that the ×1 multiplier becomes an ×2 multiplier and an ×2 multiplier becomes an ×3 multiplier) or variable increments. The increase in the multiplier is cumulative for the duration of the feature game 9 so that it will increase up to a capped or maximum of ×10 (i.e. prize values are multiplied by 10). This is done by using a multiplier meter that is not shown on the video screen 7 but is kept by electronic game controller 4 internally and stored in the volatile memory. Where the multiplier value reaches its maximum value of ×10, the electronic game controller 4 detects or is alerted to this maximum value via the internal multiplier value counter and then reconfigures the non-game reels 55, 56 to only display the Repeat Win symbol 65, the FG symbol 66 or a blank and not display the multiplier symbol. This reconfiguration results in an increased probability of the Repeat Win symbol 65 and the FG symbol 66 appearing in subsequent free spins. In other embodiments, other non-game symbols can be added to compensate for the removal of the multiplier symbol from the non-game reels 55, 56 such as credit symbols awarding bonus credits or other game enhancing symbols with associated game enhancing features.

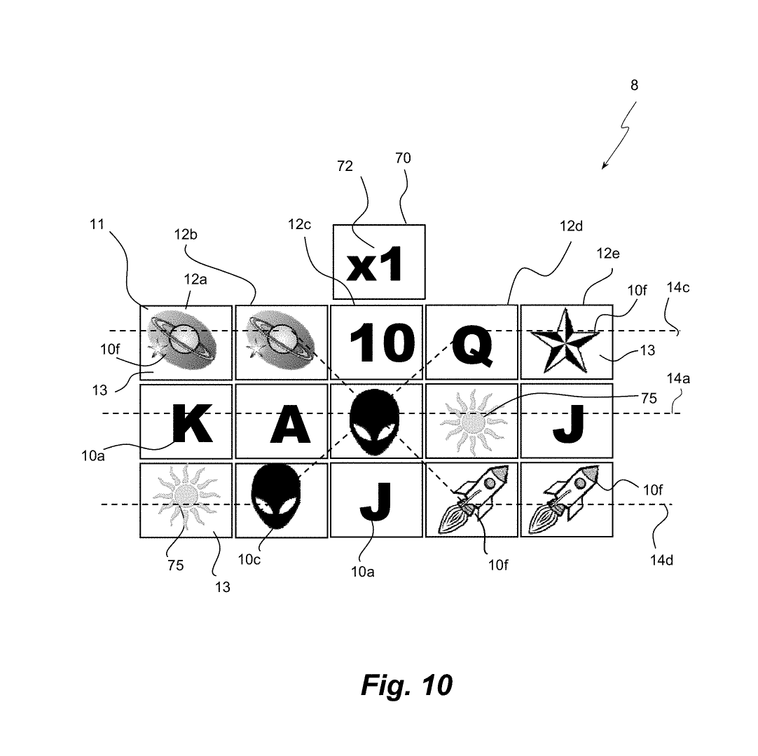

Referring to FIGS. 10 to 13, another embodiment of the present disclosure is shown, implemented as a base game 8 on the gaming machine 1. In this embodiment, a more conventional array 11 is used, comprising a 5×3 array arranged into reels 12a to 12e. A multiplier meter 70 is located adjacent the array 11 displaying a multiplier 72 having an amount of ×1. The multiplier is randomly selected by the electronic game controller 4 from a range of ×1 up to ×8. Alternatively, the multiplier is selected from one of the multiplier tables 30a to 30e from FIGS. 4A to 4E having weighted probabilities for each multiplier, based on the bet option and having one or more columns of weighted probabilities. The game symbols include playing card symbols 10a, space-themed picture symbols 10f, a substitute Alien symbol 10g and a special trigger Sun symbol 75.

The appearance of the Sun symbol 75 in a game position 13 in the array 11 comprises a trigger event in the base game 8, where any prizes that have been won in the same play of the base game 8, being a spin of the reels 12, are associated with the Sun symbol 75 by the electronic game controller. In FIG. 10, two winning combinations of game symbols appear on pay lines 14c and 14d. On pay line 14c, there is a winning combination of three Star symbols 10f (formed by one Star symbol and two substitute Alien symbols 10g) and on pay line 14d, there is a winning combination of three Planet symbols 10f (formed by two Planet symbols 10f and one substitute Alien symbol 10g, the Rocket symbols having a lower prize worth compared to the planet symbols). The prizes associated with these winning combinations of game symbols 10 are paid to the player (for example, 50 credits for three Star symbols and 30 credits for three Planet symbols). The total amount of these prizes (based on the example, 80 credits) would then be associated by the electronic game controller 4 with the Sun symbol 75.

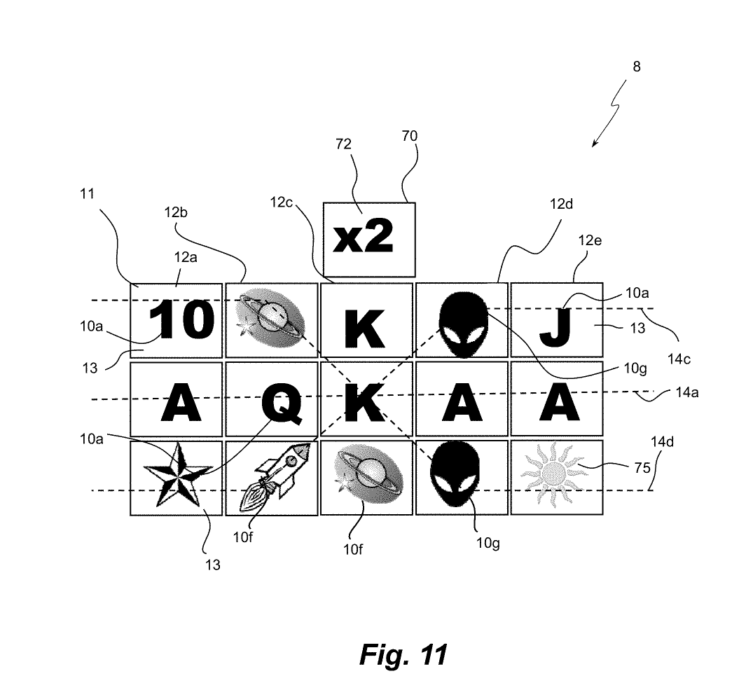

Referring to FIG. 11, in the next spin of the reels 12, a Sun symbol 75 appears on the array 11. This causes the electronic game controller 4 to award a prize associated with the Sun symbol 75, which is the total prize won by the player when the Sun symbol 75 first appeared in the base game 8, multiplied by the amount of the multiplier 72 shown in the multiplier meter 70, which for this spin has increased to ×2. In this case, the electronic game controller 4 awards the player a prize of 160 credits, being the prize associated with the Sun symbol 75 (i.e., the total prize of 80 credits initially won when the Sun symbol 75 first appeared) multiplied by the multiplier amount ×2. This is in addition to any winning combinations of game symbols 10f, 10g appearing on the reels 12. In this case, there is a winning combination of three Ace symbols 10a along pay line 14a.

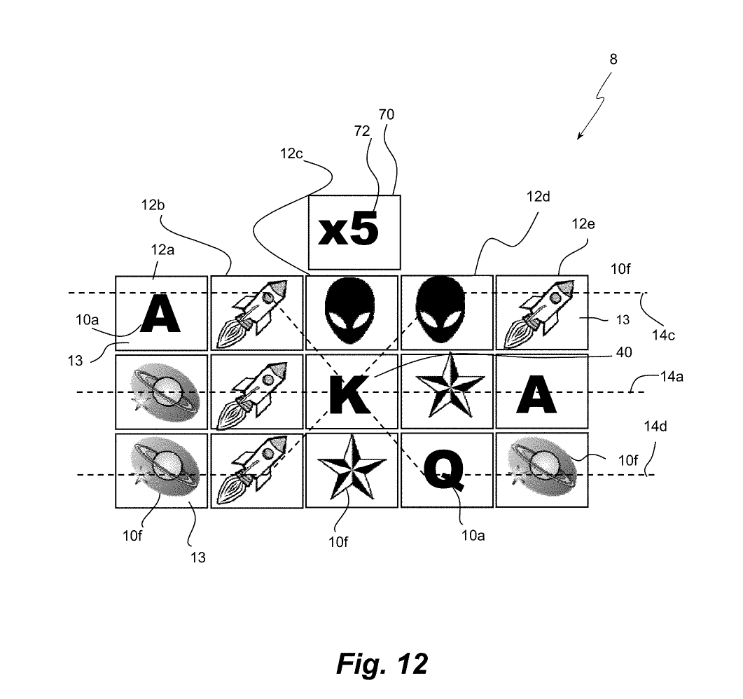

Referring to FIG. 12, in the next spin of the reels 12, no Sun symbol 75 has appeared on the array 11. Hence, there is no award of any prize associated with the Sun symbol 75 but any prizes for winning combinations of game symbols 10f, 10g appearing on the reels 12 are awarded. The multiplier meter 70 shows that the amount of the multiplier 72 has increased to ×5.

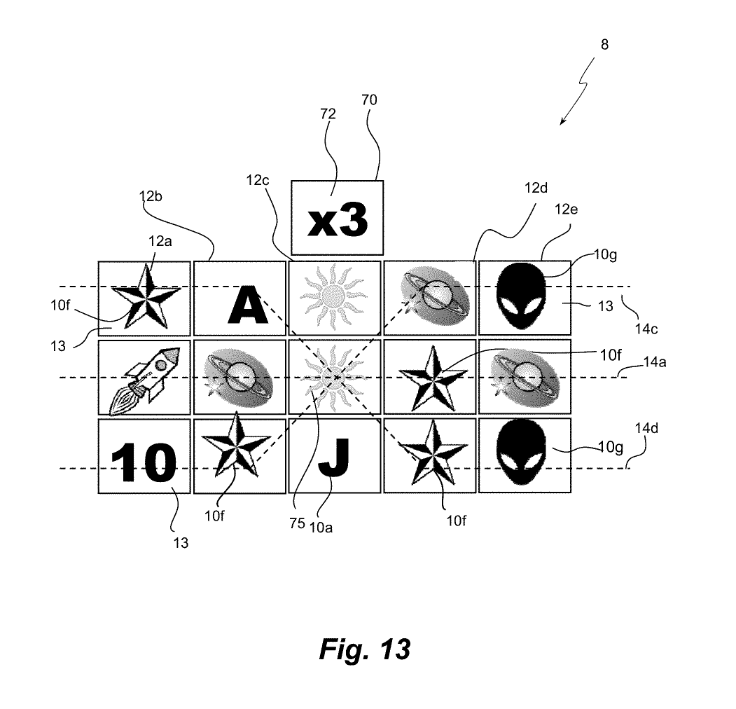

Referring to FIG. 13, in the next spin of the reels, two Sun symbols 75 have appeared on the array 11 and the multiplier meter 70 shows that the amount of the multiplier 72 has changed to ×3. In this embodiment, this would result in the prize associated with the Sun symbol 75 being paid twice; that is, a prize of 480 credits being double of the prize of 240 credits (comprising the prize of 80 credits associated with one Sun symbol 75 multiplied by the ×3 multiplier 72 shown in the multiplier meter). Again, in some embodiments, the prize conferred by the Sun symbol 75 may only be awarded once per spin, even though multiple Sun symbols 75 may appear, as in FIG. 13. In further embodiments, there is a cap on the number of times that prize awarded by the Repeat Win symbol 65 may be won at the same time. For example, the prize conferred by the Sun symbol 75 may only be awarded three times once per spin, even though more than three Sun symbols 75 may appear in the same spin.

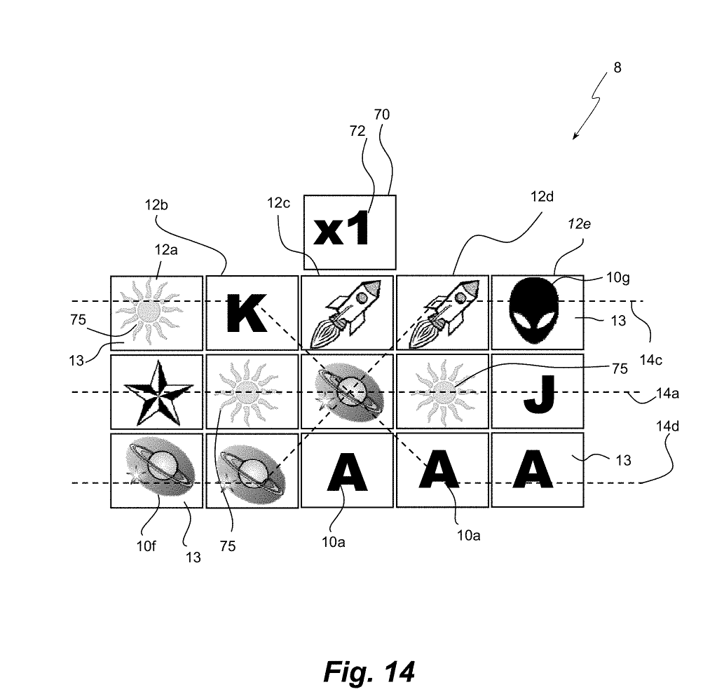

It will be appreciated that the trigger event for associating the prize(s) with the Sun symbol 75 may be varied. For example, the trigger event may require a particular combination of game symbols in order to trigger to association of the prize(s), such as five Alien substitute symbols 10g. Referring to FIG. 14, in another embodiment the trigger event comprises the appearance of three Sun symbols 75, which will associate the prize awarded for winning combinations in that spin with the Sun symbol 75 for subsequent spins of the base game 8. In FIG. 14, a winning combination of four Planet symbols 10f appears on the pay line 14c, comprising three Planet symbols 10f and one substitute Alien symbol 10g, and so the prize for this winning combination is associated with the Sun symbol 75. In this instance, only one Sun symbol 75 is required to trigger the award of the associated prize; a combination of three Sun symbols 75 was only required to associate the prize and is not required to trigger the award of the prize once associated with the Sun symbol 75.

In some embodiments, the association of the prize with the Sun symbol 75 may only last for a predetermined number of spins, such as for example, 8 spins. A counter may be used to count down the number of spins remaining to indicate to the player this period. In other embodiments, a specific time period may be used, such as 10 minutes, in conjunction with a timer to count down the period. In further embodiments, the association of the prize with the Sun symbol 75 may last when a termination symbol appears on the array 11.

In further embodiments, the range of multipliers 72 that may be randomly selected by the electronic game controller 4 may vary depending on the bet made by the player to play the base game 8. For example, a bet of 50¢ may only provide a range of multipliers from ×1, ×2 and ×3, whereas a bet of $1 may provide a range of multipliers from ×2, ×3, ×5 and ×8 and a bet of $2 may provide a range of multipliers from ×5, ×8 and ×10.

In some embodiments, the frequency of the special symbols 65, 75 displayed in the arrays 11, 50 controlled by choosing different reel strips to display the special symbols 65, 75 in the base game 8 and feature game 9. Thus, more special symbols 65, 75 as the bet made by the player increases. This means that the frequency of potentially associating prize(s) with the special symbols 65, 75 and winning those associated prize(s) increases. There may also be a combination of frequency of the special symbols 65, 75 and using different reel strips for reels 12 with a higher frequency of higher worth game symbols or substitute symbols.

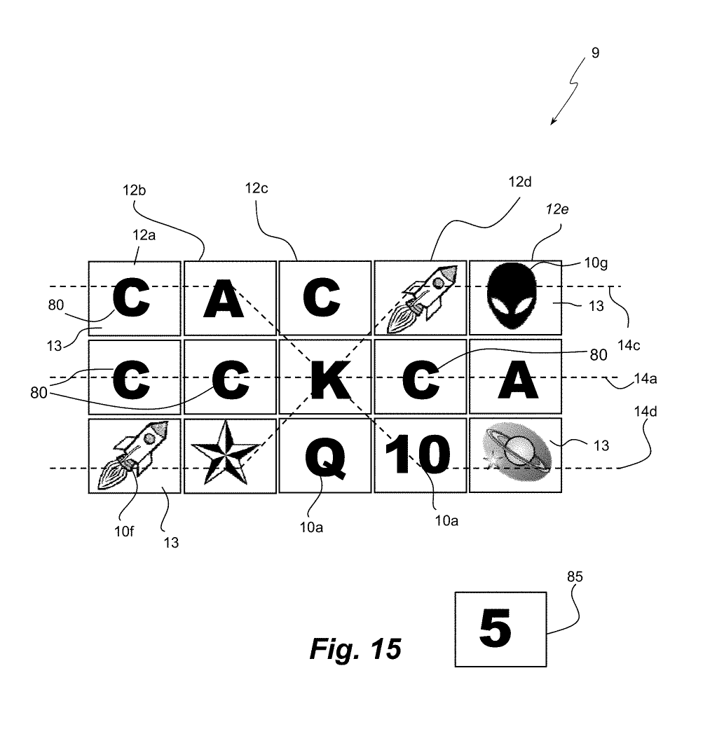

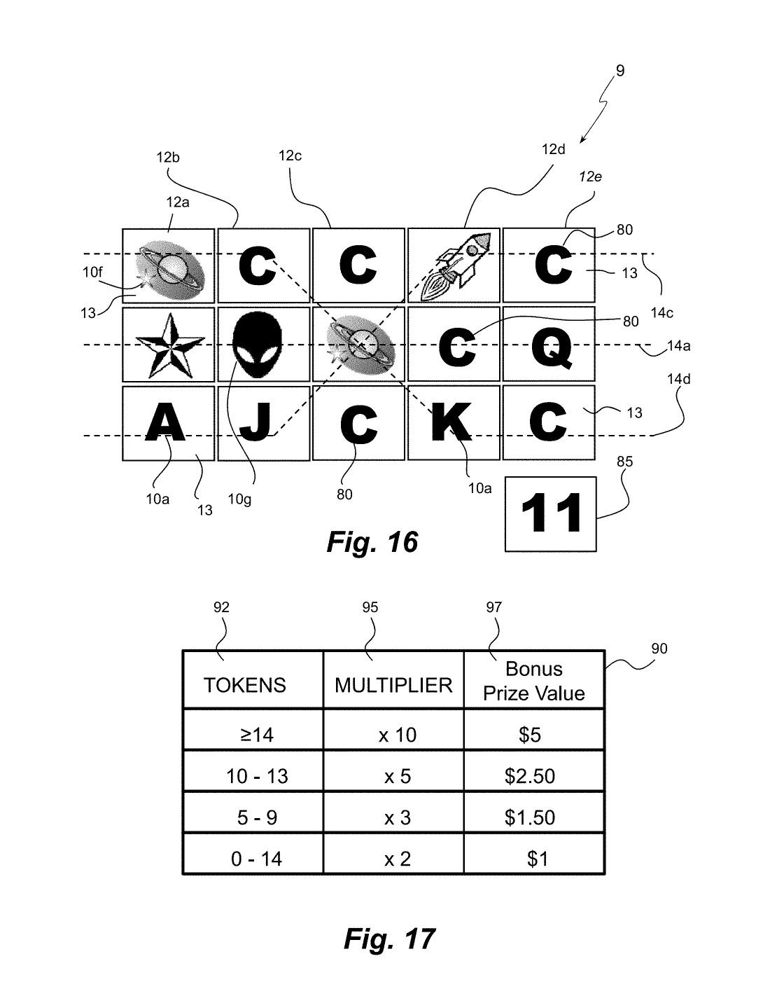

Referring to FIGS. 15 to 17, a further embodiment of the present disclosure is illustrated, where a feature game 9 is triggered in the conventional way, by the appearance of three or more scatter symbols in the base game 8 (such as for example illustrated in FIG. 14). In the feature game 9, special collector or token “C” symbols 80 randomly appear in the game positions 13 of the reels 12a to 12e during the free game spins. As best shown in FIG. 15, five token C symbols 80 appear in the reels 12a to 12e and the total number of collected token C symbols are indicated by a token counter 85. In the next free game spin shown in FIG. 16, another six token C symbols have appeared, bringing up the token counter 85 from 5 to 11. The token C symbols 80 are collected or accumulated by the player over the duration of the feature game 9.

At the end of the feature game 9, the number of collected token C symbols are totalled or added up and if a threshold number of the token C symbols have been collected, the electronic game controller 4 awards a multiplier that is applied to a predefined amount to calculate a collected token or bonus prize that is in addition to the prizes already won for winning combinations of game symbols 10 appearing during play of the feature game 9. In this embodiment, the predefined amount is the bet or wager made by the player, which can be a bet option, the bet per pay line 14 or the total bet to play the base game 8.

In addition, the amount of the multiplier increases values as more token C symbols 80 are collected. Referring to FIG. 17, a bonus prize table 90 is shown in the upper display area of the video screen 7 above the playing area 7a that shows the feature game 9. The bonus prize table 90 indicates the number of token C symbols 80 in column 92 required for each multiplier shown in column 95 and the associated bonus prize value awarded in column 97. The bonus prize value is calculated from the base bet option times the multiplier indicated in the column 95. In this case, the player has made a base bet of 50¢ and assuming that no further token C symbols 80 have appeared in the remainder of the feature game, the player would receive an ×5 multiplier for collecting 11 token C symbols 80. This results in a bonus prize award of $2.50 for the base bet of 50¢. If, on the other hand, the player did not collect any further token C symbols 80 after the free games spin shown in FIG. 15, he or she would only receive an ×3 multiplier, which would result in a bonus prize award of $1.50. It can thus be seen that the awarded multiplier significantly increases the amount of the total prizes won in the feature game 9 and that increasing the player bet confers a greater chance of obtaining bonus prizes of greater amounts. In this embodiment, the feature game 9 cannot be retriggered to provide further free game spins and thus increase the chances of obtaining more token C symbols 80 and hence higher amounts of bonus prizes. However, in other embodiments, the feature game 9 may be retriggered by the occurrence of a special retrigger symbol that has a higher chance of appearing where a small number of token C symbols 80 have been collected (such as only zero, one or two token C symbols).

Hence, the embodiments of the present disclosure enable the gaming machine 1 to award additional prizes to those that can be obtained from standard combinations of game symbols 10 displayed in the array 11, 50. This increases the probability of the player winning a prize and/or a prize of higher amounts than is ordinarily possible. By tying the additional prize to the amount bet or a previously won prize amount, an easily understood link or reason for the additional prize is provided to the player and in a more entertaining manner. Thus, the embodiments permit additional prizes of potentially higher worth to be won more frequently in a more entertaining manner to the player.

It will be appreciated that one skilled in the art will recognise that the term “volatility” refers to the expected frequency of winning game events occurring and the corresponding amount paid for each winning game event in order to maintain the required payout level set for the gaming machine. Thus, the amount paid for each winning combination and the level of return to the player determines the “volatility” of the gaming machine. For example, a gaming machine with low volatility is configured to have a relatively high frequency of “wins”, where each win has a relatively low value. Conversely, high volatility refers to a lower frequency of “wins” of correspondingly higher value. Throughout the specification, “volatility” is a reference to this characteristic of a gaming machine.

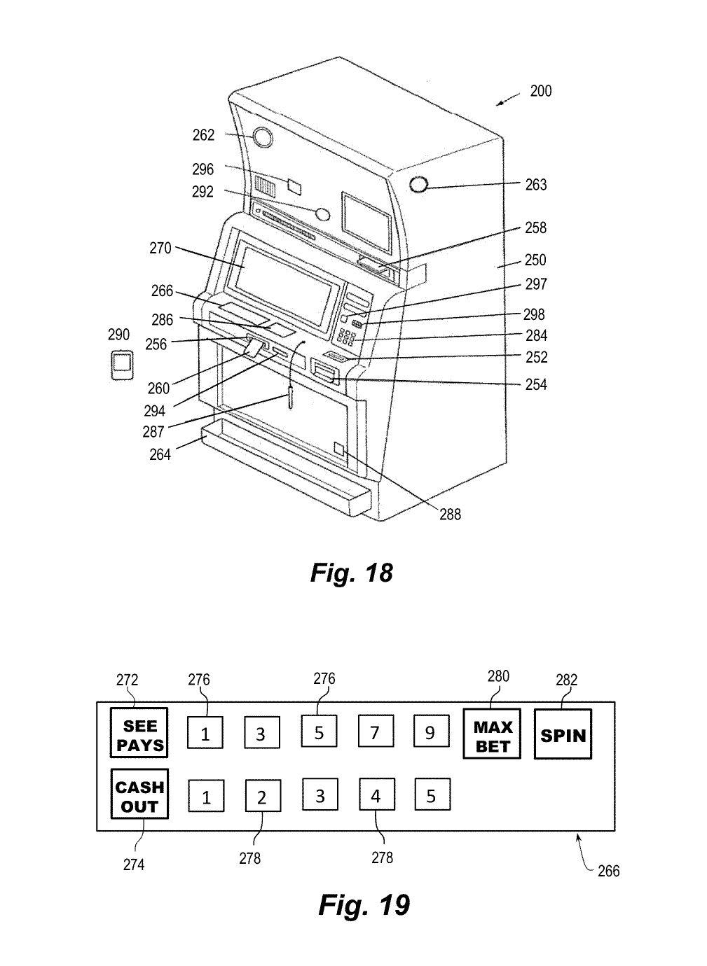

Referring to FIG. 18, another embodiment is shown in the form of an electronic gaming machine 200. The electronic gaming machine 200 may include a housing or cabinet 250 and one or more value transfer mechanisms or devices, which may include a coin slot or acceptor 252, a paper currency or bill acceptor 254, a ticket reader/printer 256 and a card reader 258, which may be used to input value to the electronic gaming machine 200. A value transfer device may include any device that can accept value from a player. The topper (not shown) may be mounted to the top of the electronic gaming machine 200.

If provided on the electronic gaming machine 200, the ticket reader/printer 256 may be used to read and/or print or otherwise encode ticket vouchers 260. The ticket vouchers 260 may be composed of paper or another printable or encodable material and may have one or more of the following informational items printed or encoded thereon: the casino name, the type of ticket voucher, a validation number, a bar code with control and/or security data, the date and time of issuance of the ticket voucher, redemption instructions and restrictions, a description of an award, and any other information that may be necessary or desirable. Different types of ticket vouchers 260 could be used, such as bonus ticket vouchers, cash-redemption ticket vouchers, casino chip ticket vouchers, extra game play ticket vouchers, merchandise ticket vouchers, restaurant ticket vouchers, show ticket vouchers, etc. The ticket vouchers 260 could be printed with an optically readable material such as ink, or data on the ticket vouchers 260 could be magnetically encoded. The ticket reader/printer 256 may be provided with the ability to both read and print ticket vouchers 260, or it may be provided with the ability to only read or only print or encode ticket vouchers 260. In the latter case, for example, some of the electronic gaming machines 200 may have ticket printers 256 that may be used to print ticket vouchers 260, which could then be used by a player in other electronic gaming machines 200 that have ticket readers 256.

If provided, the card reader 258 may include any type of card reading device, such as a magnetic card reader or an optical card reader, and may be used to read data from a card offered by a player, such as a credit card or a player tracking card. If provided for player tracking purposes, the card reader 258 may be used to read data from, and/or write data to, player tracking cards that are capable of storing data representing the identity of a player, the identity of a casino, the player's gaming habits, etc.

The electronic gaming machine 200 may include one or more audio speakers 262, a coin payout tray 264, an input control panel 266, and a colour video display unit 270 for displaying images relating to the game or games provided by the electronic gaming machine 200. The audio speakers 262 may generate audio representing sounds such as the noise of spinning reels, a dealer's voice, music, announcements or any other audio related to a game. The input control panel 266 may be provided with a plurality of pushbuttons or touch-sensitive areas that may be pressed by a player to select games, make wagers, make gaming decisions, etc.

FIG. 19 illustrates one possible embodiment of the control panel 266, which may be used where the electronic gaming machine 200 having a plurality of reels. The control panel 266 may include a “See Pays” button 272 that, when activated, causes the display unit 270 to generate one or more display screens showing the odds or payout information for the game or games provided by the electronic gaming machine 200. As used herein, the term “button” is intended to encompass any device that allows a player to make an input, such as an input device that must be depressed to make an input selection or a display area that a player may simply touch. The control panel 266 may include a “Cash Out” button 274 that may be activated when a player decides to terminate play on the electronic gaming machine 200, in which case the electronic gaming machine 200 may return value to the player, such as by returning a number of coins to the player via the payout tray 264.

The control panel 266 may be provided with a plurality of selection buttons 276, each of which allows the player to select a different number of pay lines prior to spinning the reels. For example, five buttons 276 may be provided, each of which may allow a player to select one, three, five, seven or nine pay lines.

The control panel 266 may also be provided with a plurality of selection buttons 78 each of which allows a player to specify a wager amount for each pay line selected. For example, the electronic gaming machine 200 may be provided with five selection buttons 78, each of which may allow a player to select 1¢, 2¢, 5¢, 10¢ and 20¢, to wager for each pay line selected. In that case, if a player were to activate one of the buttons 276 to select five pay lines and then activate one of the buttons 278 to select 5¢ per pay line to be wagered or bet, the total wager would be $0.25.

The control panel 266 may include a “Max Bet” button 280 to allow a player to make the maximum wager allowable for a game. In the above example, where up to nine pay lines were provided and up to 20¢ could be wagered for each pay line selected, the maximum wager would be $1.80 The control panel 266 may include a spin button 282 to allow the player to initiate spinning of the reels after a bet has been made.

In FIG. 19, a rectangle is shown around the buttons 272, 274, 276, 278, 280, 282. It should be understood that the rectangle simply designates, for ease of reference, an area in which the buttons 272, 274, 276, 278, 280, 282 may be located. Consequently, the term “control panel” should not be construed to imply that a panel or plate separate from the housing 250 of the electronic gaming machine 200 is required, and the term “control panel” may encompass a plurality or grouping of player activatable buttons.

Although one possible control panel 266 is described above, it should be understood that different buttons could be utilized in the control panel 266, and that the particular buttons used may depend on the game or games that could be played on the electronic gaming machine 200. Although the control panel 266 is shown to be separate from the display unit 270, it should be understood that the control panel 266 could be generated by the display unit 270. In that case, each of the buttons of the control panel 266 could be a coloured area generated by the display unit 270, and some type of mechanism may be associated with the display unit 270 to detect when each of the buttons was touched, such as a touch-sensitive screen.

As noted above, the electronic gaming machine 200 may include a mechanism by which the electronic gaming machine 200 may determine the identity of the player. In particular, the card reader 258 may be used to read a card that carries an identification code that may be uniquely associated with the player so that the gaming unit can differentiate that player from all other players, or so that the gaming unit can differentiate that player as a member of a group of players from all player not a member of the group of players. The electronic gaming machine 200 may also include equipment, such as a keypad 284, an input pad 286 (with optional stylus 287), a port (or antenna) 288 adapted to communicate via a wired or wireless link (infrared or radio frequency link, for example) to a mobile electronic device 290 (such as a personal digital assistant, smart phone or tablet), a camera 292, a scanner 294, a retinal (or iris) scanner 296, fingerprint scanner 297, and/or a microphone 298. The electronic gaming machine 200 may include any one of the devices 258, 284, 286, 288, 290, 292, 294, 296, 297, 298, or the electronic gaming machine 200 may include a combination of some or all of the devices 258, 284, 286, 287, 288, 290, 292, 294, 296, 297, 298.

In operation, a player may identify him or herself to the electronic gaming machine 200 by entering a unique numeric or alpha-numeric code using the key pad 284, for example. Alternatively, the player may use his or her finger or the stylus 287 to sign his or her signature on the input pad 286. As a further alternative, the player may sign his or her signature on the mobile electronic device 290, which signature is then converted to electronic data, and the data is then transferred via the port/antenna 288 to the electronic gaming machine 200. As yet another alternative, the player may sign his or her signature on a piece of paper that is then photographed using the camera 292 or scanned using the scanner 294 (or the bill acceptor 254) to convert the signature into electronic data. As an additional alternative, the player may place one of his or her fingers or his or her hand on the scanner 297, and the scanner 297 may generate an electronic data representation of the fingerprint on one or more of the players fingers or an electronic data representation of the pattern of the entire hand. Alternatively, the camera 292 may be used to take a picture (live or still) of the player, the picture then being converted into electronic data. As a still further alternative, the player may place his or her eye up to the retinal (or iris) scanner 296, and the retinal (or iris) scanner 296 may generate an electronic data representation corresponding to the pattern of the retina (or iris) of the player. As yet another alternative, the player may speak into the microphone 298, and characteristics of the spoken words (or voiceprint) may be converted into an electronic data representation.

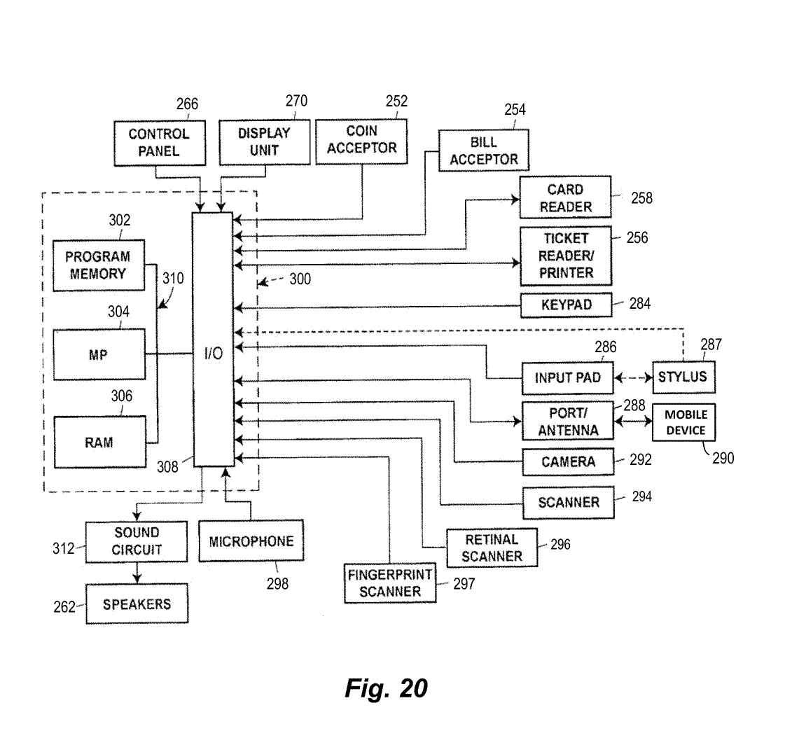

FIG. 20 is a block diagram of a number of components that may be incorporated in the electronic gaming machine 200. Referring to FIG. 20, the electronic gaming machine 200 may include a controller 300 that may comprise a program memory 302, a microcontroller or microprocessor (MP) 304, a random-access memory (RAM) 306 and an input/output (I/O) circuit 308, all of which may be interconnected via an address/data bus 310. It should be appreciated that although only one microprocessor 304 is shown, the controller 300 may include multiple microprocessors 304. Similarly, the memory of the controller 300 may include multiple RAMs 306 and multiple program memories 302. Although the I/O circuit 108 is shown as a single block, it should be appreciated that the I/O circuit 308 may include a number of different types of I/O circuits. The RAM(s) 304 and program memories 302 may be implemented as semiconductor memories, magnetically readable memories, and/or optically readable memories, for example.

FIG. 20 illustrates that the coin acceptor 252, the bill acceptor 254, the ticket reader/printer 256, the card reader 258, the control panel 266, the display unit 270, the keypad 284, the input pad 286 (and optionally the stylus 287), the port/antenna 288, the digital camera 292, the scanner 294, the retinal scanner 296, the fingerprint scanner 297 and the microphone 298 may be operatively coupled to the I/O circuit 308, each of those components being so coupled by either a unidirectional or bidirectional, single-line or multiple-line data link, which may depend on the design of the component that is used. The speaker(s) 262 may be operatively coupled to a sound circuit 312, that may comprise a voice- and sound-synthesis circuit or that may comprise a driver circuit. The sound-generating circuit 312 may be coupled to the I/O circuit 308.

As shown in FIG. 20, the components 252, 254, 256, 258, 266, 270, 284, 286, 287, 288, 292, 294, 296, 297, 298, 312 may be connected to the I/O circuit 308 via a respective direct line or conductor. Different connection schemes could be used. For example, one or more of the components shown in FIG. 18 may be connected to the I/O circuit 308 via a common bus or other data link that is shared by a number of components. Furthermore, some of the components may be directly connected to the microprocessor 304 without passing through the I/O circuit 308.

In some embodiments, at least one of the game symbols comprises a game enhancing symbol that confers a game enhancing element to the player. It is further preferred that the game enhancing element modifies the result of a play of the game, which can be any one or combination of the base game 8 and feature game. The game enhancing elements may provide different types of effects or modifications of the game play result. In one embodiment, the game enhancing element comprises the award of one or more plays of the game that do not require a bet from the player. In other words, the game enhancing element awards a predetermined number of “free” games. In some embodiments, the game enhancing element comprises at least one or more a win multiplier, wild multipliers, bonus wilds, symbols that cause the award of additional free games, trigger symbols to retrigger the at least two second arrays, held columns, random wild symbols, stacked symbols, bonus symbols, new game symbols, reveal symbols, progressives, bonus credits, jackpot symbols, and one or more symbol replacements. A variety of game enhancing elements can be awarded by the game enhancing symbols, including:
symbols that award a predetermined number of free plays of the game;
win multiplier symbols that multiply the amount of any win from one of the predetermined winning combinations;
“wild” symbols that cause the display of substitute symbols in randomly selected symbol positions;
bonus symbols that awards a bonus prize, either as a monetary amount or as a bonus credit;
wild multiplier symbols that cause the display of substitute symbols on the array 11 and multiplies the amount of any win from one of the predetermined winning combinations;
bonus wild symbols that cause the display of substitute symbols on the array 11 and awards a bonus prize;
symbols that cause the award of additional free plays of the game;
symbols that cause one or more of the symbol positions to be held static (typically one or more reels 12a to 12e) and display substitute symbols on the array 11;
symbols that cause the same game symbol to be stacked in a group of symbol positions, typically the group being one or more reels 12a to 12e;
symbols that cause the display of new game symbols on the array 11;
“reveal” symbols that cause a game symbol to reveal another game symbol; and
“replacement” symbols that cause one or more game symbols to be replaced by other game symbols in the array 11.

These game enhancing symbols do not modify the function or value of the game symbols 10 that appear on the arrays 11, but instead confer bonus prizes, free games or change existing game symbols for other game symbols (such as replacing picture, royal card or symbols belonging to a reel with wild/substitute symbols). Where the function of game symbols 10 have been changed or the game symbols 10 are replaced, then this modification can take effect with the next play of the game instead of applying to the result of the spun array 11. In another embodiment, the game enhancing symbols may indicate the duration in which its game enhancing element is applied, such as a predetermined number of spins or a predetermined time period.

It will be appreciated that in other embodiments, game enhancing elements can also be awarded as a separate aspect of the games 8, 9. The game enhancing elements may further be awarded in addition or as an alternative to the enhanced prizes awarded based on winning combinations of game symbols 10 in the games 8, 9. In a further embodiment, the award of game enhancing elements can be done by way of a sixth reel or the appearance of game enhancing symbols in the reels 12a to 12e. The sixth reel in this case is simply added as an extension to the array 11 and spins either game enhancing symbols or “blank” symbols.

In some embodiments, the game enhancing symbols include “collector”-type game enhancing symbols that award points or tokens. The collection of points or tokens during the base game 8 and/or feature game 9 leads to the trigger of additional prizes or game enhancing symbols, depending on the number of points or tokens that are collected. These additional prizes can include stand alone progressive jackpots, bonus prizes and super games, which are enhanced versions of free spins or games where there are greater pay outs or frequency of wins.

In other preferred forms, the game enhancing element can be an enhanced version of the array 11. The enhanced array may provide additional game enhancing symbols that include the award of points or an additional number of free spins of the array 11 (for example, retriggering 5 more free spins). The collection of points awarded by the enhanced array during free spins or game leads to the trigger of additional prizes or game enhancing symbols, depending on the number of points that are collected. These additional prizes can include stand alone progressive jackpots, bonus prizes and super games, which are enhanced versions of free spins or games where there are greater pay outs or frequency of wins. In addition, the enhanced array has a different visual representation to the array 11. In addition, the enhanced array may provide game enhancing symbols of greater value and/or frequency compared to the array 11.

Where the game enhancing element comprises the award of a jackpot prize, it can take the form of a standalone progressive jackpot, fixed jackpot, mystery jackpot, symbol driven jackpot and any combination thereof (i.e. a mixture of different types of jackpots). In some embodiments, the jackpots are limited to the feature game 9. In other embodiments, the jackpots are shared by all the games 8 and 9. That is, the jackpots could be won through play of the games 8 and 9.

A progressive jackpot prize takes a portion of each bet (typically a set percentage of each bet) made on the gaming machine and thus the amount of the progressive jackpot incrementally increases as more bets are made on the gaming machine 1. The progressive jackpot is typically awarded when a winning game combination associated with the jackpot occurs in the game played on the gaming machine. In many cases, progressive jackpots are associated with the least probable winning combination and are commonly the highest paying award of the gaming machine. In other cases, a separate trigger event can be used to award the progressive jackpot prize, such as a special jackpot symbol, a trigger event internally generated by the electronic game controller. Alternatively, or additionally, once a certain threshold is met, either a certain amount that has been bet on the gaming machine or the incremented amount of the progressive jackpot, a trigger event is activated in the electronic gaming machine to pay out the progressive jackpot prize. Progressive jackpot prizes also tend to be shared amongst multiple gaming machines so as to increase the amount of the progressive jackpot prize and hence increase player interest in playing one of the electronic gaming machines. In some gaming machines, more than one jackpot or progressive jackpot are offered by the gaming machine or gaming machines linked together.

The jackpot or bonus prizes may also be mystery jackpots rather than symbol driven jackpots. That is, none of the symbols in the game trigger the jackpot; hence, the trigger event is a “mystery”. By way of comparison, a standard jackpot is typically symbol driven in that a particular combination of symbols must occur in the game to trigger the standard jackpot.

The trigger event for the mystery jackpot can be one randomly generated by the electronic game controller 4 for each play of the games 8 and 9. One way to implement the random determination of the trigger event is for the electronic game controller 4 to internally generate a random number and check if it is a predetermined number or within a predetermined range of numbers that will initiate the appearance of the trigger symbols. For example, the predetermined range of numbers could be the range of numbers between 1 and 10 and the electronic game controller 4 internally generates a random number between 1 and 100. If the generated number is any one of numbers 1 to 10, then this results in the electronic game controller 4 causing the trigger event to occur and award the progressive jackpot prize. It will be appreciated that this manner of determining the jackpot trigger event may also be used to determine whether the feature game 9 is triggered in the base game 8.

Progressive jackpots can be confined to the gaming machine 1 as so called “standalone” progressive jackpots. Alternatively, the jackpot is a wide area or an in-house linked progressive jackpot prize. In other embodiments, one or more the progressive jackpot prizes are configured to be part of a wide area or in-house linked progressive jackpot prize. In other words, the progressive jackpot prizes can be awarded on a group of networked gaming machines in a specified area or a group of specified gaming machines that are linked together for jackpot purposes (usually via a central jackpot controller). The jackpot prizes can also be shared with any other games offered on the same gaming machine 1 (as in multi-game gaming machines).

During play of the games 8 and 9, the electronic game controller 4 will determine whether the trigger event for the jackpot has occurred. In response to the occurrence of the jackpot trigger event(s), the electronic game controller 4 transmits a signal to the video screen 7 to cause the jackpot(s) associated with the jackpot trigger event(s) to be awarded to the player. After the jackpot(s) are awarded, the amounts for any awarded jackpots are reset. The amounts of the jackpots that have been won can be reset either to a predetermined start amount or simply increment upwardly from zero where the won jackpot is a progressive jackpot.

In some embodiments, the in-game trigger event is determined at the end or during the play of the game; i.e. at the end or during a spin of the reels 12. In some embodiments, the in-game trigger event occurs in a preceding play of the game so that the result of the in-game trigger event takes place in a subsequent play of the game, typically the next play of the game after the preceding play but could include a later successive play of the game.

Furthermore, the embodiments of the present disclosure have been described as providing a standard 5×3 array for the base game 8 and the feature game 9. However, it will be appreciated that in other embodiments, the size and shape of the base game array 11 and feature game array may vary as desired. For example, the arrays 11 could take any number of different shapes, such as triangular, circular, square, hexagonal, hemi-spherical or other polygonal shapes. For example, the base game array 11 could comprise a circular array having three rings (equivalent to rows) like a bullseye target segmented into five columns. The feature game array would then expand into additional rings surrounding the initial rings of the base game array 11. Alternatively, the arrays 11 could have an unequal number of rows or columns. For example, the reels 12a, 12b could have three rows, but the reels 12c to 12e could have four rows.

While the preferred embodiment has been described in relation to both a base game 8 and a feature game 9, those skilled in the art will appreciate that the use of an associated prize with a trigger event can readily be applied to the base game alone or a feature game alone.

In some embodiments, the bonus or jackpot prizes are selected after an initial random assignment of multiplier values and/or base values, where the randomly assigned multiplier and/or base values are weighted to increase as the amount of the bet made by the player to play the base game 8 increases.

In some embodiments, the number of Mini and Major bonus prize symbols act as multipliers for the Mini and Major bonus prizes. That is, the number of Mini and Major bonus prize symbols multiplies the amount of the Mini and Major bonus prizes won by the player at the conclusion of the feature game. In other words, each Mini and Major bonus prize symbol represents its own Mini and Major bonus prize that can be won multiple times.

In a further variation to the embodiment, additional jackpots are awarded for filling a predetermined number of the game positions with the special symbol. For example, if the player is able to accumulate special symbols in thirteen game positions, then he or she would receive a Maxi progressive jackpot. If the player is able to accumulate special symbols in special game positions, then he or she would receive a Major progressive jackpot. If the player is able to accumulate special symbols in all fifteen game positions of the array, then he or she would receive a Grand progressive jackpot. Thus, more generally, a threshold number of game positions displaying the special symbol results in the award of a bonus prize of higher worth and in some embodiments that threshold number is a majority of the number of the available game positions 13 in the array 11.

Another variation to the embodiment awards a free spin for each special symbol displayed in a game position 13 in the array 11. Thus, if the player completes the array 11, he or she would receive nine free spins. Thus, more generally additional plays of the game are awarded as the number of game positions 13 displaying the special symbol increases. Where the player still has a number of free spins remaining when the array 11 is completed, and the remaining free spins are used for the following game. Alternatively, the game also ends when all fifteen game positions 13 are filled with the special symbol and the player wins the Grand progressive jackpot.

Yet another variation to the embodiment, the bonus or jackpot prize values increase as more game positions 13 displaying the special symbol appear on the array 11, thus increasing the value of the potential prizes to be won. Alternatively, the bonus or jackpot prize values increment (with each spin of a free game by the amount of the bet made by the player.

In other embodiments, the gaming machine 1 also offers the player the opportunity to play in community games against other players in so-called tournament games, or even in player versus player games. This is typically implemented by electronically linking several gaming machines 1 in a group within a gaming venue. The player versus player or tournament game can be played simultaneously by the players or can be staggered, with some players playing at one time and some players playing at another time in the same game. In this situation, the player versus player or tournament game comprises the award of an additional bonus prize in addition to the jackpot prizes in the selected available jackpot set.

While the same game format is essentially used across the base game 8 and feature game 9, it will be appreciated that the game format may vary across the base and feature games, as well as between base games where more than one game is offered by the same electronic gaming machine 1. For example, one of the games 8 may be a wheel-type game or a four reel game and another of the games may be a standard five reel game. Similarly, the games 8 may each have different game symbols, game rules and pay tables that are unique to each game.

While one embodiment has been described in relation to a base game 8 and a feature game 9, it will be appreciated that the present disclosure could include one or more additional feature games that are triggered by specific trigger symbols appearing in the feature game 9. Also, the additional feature games may also have trigger symbols that trigger further feature games in a cascading fashion. These additional and further feature games could have the same game play elements as the feature game 9 or be different feature games entirely.

In other embodiments, the base game 8 and the feature game 9 need not be displayed alternately on a single video screen 7. Instead, they may be displayed on the same video screen 7, with the base game 8 shown in the lower playing area 7a and the feature game 9 shown in the upper display area of the video screen 7. Alternatively, the base game 8 and the feature game 9 are shown on separate video screens, with the base game 8 shown in a lower video screen corresponding to the lower playing area 7a and the feature game 9 shown in an upper video screen corresponding to the upper display area. Also, the order can be reversed, with the lower playing area 7a or video screen showing the feature game 9 and the upper video screen or upper playing area of a single video display screen 7 showing the base game 8.

In another embodiment, the video screen 7 is a touch screen for use in addition to the player-actuatable buttons 6 so as to enable the player to select the bet level (such as bet denominations or bet per pay line 14) as well as other various features, such as making monetary bets for the game, initiating play of any base and feature games played and responding to any messages or requests issued on the gaming machine 1 by the electronic game controller 4. In this case, the player may control when the reels 12 start spinning and stop spinning, either individually or collectively, by simply touching the reels 12. Control over spinning of the reels 12 can also be implemented through the buttons 6 on the console 3. This increases player interaction and provide the player with an opportunity to guess when a particular game symbol 10 may appear in the reels 12.

In some embodiments, in response to a feature game trigger event in the base game, the electronic controller causes the display to display game symbols for playing the feature game. Alternatively, the electronic controller causes the display of the feature game and the base game during play of the base game, the feature game being inactive until triggered. In this embodiment, the change in the feature game from being inactive to active may be indicated on the display. This indication may be visual, aural or a combination of both.

In some embodiments, the gaming machine comprises an input device for receiving commands from the player to play the game, wherein the input device comprises one or more buttons in electronic communication with the electronic controller to transmit the player commands to the electronic controller.

In some embodiments, the input device comprises one or more buttons on the housing, the buttons being in electronic communication with the electronic controller. In other embodiments, the buttons are arranged on a console of the housing. Alternatively or additionally, the input device comprises a touch sensitive surface on the display for receiving commands from the player, the touch sensitive surface being in electronic communication with the electronic game controller to transmit the player commands to the electronic controller.

In some embodiments, the gaming machine comprises a value transfer mechanism for receiving value from the player to make a bet and initiate a play of the game. In other embodiments, the value transfer mechanism also pays the prizes to the player using value in an amount equal to an awarded prize. It is further preferred that the housing comprises the value transfer mechanism. In one embodiment, the value transfer mechanism comprises one or more vending slots for paying and/or receiving value. In other embodiments, the value transfer mechanism comprises a value input/value output device. In further embodiments, the value transfer mechanism comprises a coin slot or acceptor, a paper currency acceptor, a ticket reader and/or printer or a card reader and/or writer.

In a further variation to the embodiments, each game or symbol position 13 comprises its own individual reel and three of the reels are grouped into columns 12a to 12e of reels. That is, each symbol position 13 has its own individual reel strip of game symbols.

In some embodiments, a threshold number of special symbols displayed in the special game positions results in the award of a bonus prize of higher worth. In other embodiments, the threshold number of special symbols comprises a majority of the number game positions in the array. In other embodiments, additional plays of the game are awarded as the number of special symbols displayed in the special game positions increase.

In some embodiments, the game enhancing element comprises at least one or more of a predetermined number of free games, a win multiplier, wild multipliers, bonus wilds, symbols that cause the award of additional free games, trigger symbols to retrigger the at least two second arrays, held columns, random wild symbols, stacked symbols, bonus symbols, new game symbols, reveal symbols, progressives, bonus credits, jackpot symbols, and one or more symbol replacements.

In some embodiments, the base game and the feature game each comprises an array of rows and columns of the predetermined game positions, and the base game array is different in size and/or dimensions to the feature game array. In other embodiments, the feature game array is greater in size than the base game array. In one preferred form, the base array comprises three rows and five columns and the feature game array comprises either more than three rows or more than five columns. In a further preferred form, the feature game array is an extended base game array.

In some embodiments, a feature game trigger event occurs in the base game to trigger the feature game. In one embodiment, the feature game trigger event comprises a random event determined by the electronic game controller at the start of play of the feature game. In another embodiment, the feature game trigger event comprises the appearance of at least one trigger symbol in the base game array. In another alternative, the feature game trigger event comprises an in-game event during play of the base game.

In some embodiments, the array (including the base game array and/or the feature game array) take any one of a circular, triangular, oval, semi-circular, hexagonal, pentagonal, octagonal, non-rectangular or polygonal shape. In one preferred form, the wheels and the enhanced wheels arrays take the form of partially shown circular wheels.

In some embodiments, the player selectively starts and/or stops play of the base game array and/or the feature game array.

In some embodiments, the game symbols may be used to play a slots-type game. In other embodiments, the game symbols may be used to play a poker-type game. In further embodiments, the game symbols may be used to play a bingo or keno-type game

In some embodiments, the gaming machine comprises a mobile electronic gaming device. In other embodiments, the mobile electronic gaming device comprises a handheld electronic device. In one preferred form, the handheld electronic device comprises a handheld electronic gaming device or a smart phone. Alternatively, the gaming machine comprises a computer. In other embodiments, the computer is connected to a communication network.

It will be appreciated that while the preferred embodiments have been described in relation to an industry standard electronic gaming machine, the present disclosure can be readily applied to other types of electronic gaming machines, including a personal computer (standing alone or connected to a communications network, LAN or WAN), mobile electronic devices (such as handheld or portable electronic devices like tablets and smart phones) and other electronic devices capable of displaying a game. In the case of mobile electronic device, in one arrangement it may permit the player to make bets using “virtual” credits that represent a monetary value, but do not require the player to make a monetary transaction. Instead, the present disclosure may provide a tiered access to the various features of the game so that the player can make relatively small payments to access particular features of the game or obtain additional benefits during game play. An alternative arrangement would require the player to purchase virtual credits or tokens via an interface on the mobile electronic device or an online interface accessible by the mobile electronic device. Similarly, either of the above described arrangements can be applied where the present disclosure is implemented on a personal computer (PC) connected to the internet (wirelessly or not). In one example of the implementation, the PC would access an online casino over the internet to play the game of the present disclosure or the game of the present disclosure would be part of a social networking website. It is also contemplated that the player could also make regular payments to subscribe to continue playing the game on the mobile electronic device, PC or other electronic device.

In an alternative embodiment, the gaming machine also provides an option for the player to play with either credits based on a monetary amount or virtual credits as discussed above. This can be implemented by way of a selection menu prior to playing the selected game or by providing a suitable menu button on screen during play of the selected game.

In another aspect, the present disclosure includes a computer programme configured to perform the present disclosure. In this way, the present disclosure can be implemented in various ways on a gaming machine. In a further aspect, the present disclosure includes a gaming system configured comprising a central processing unit (such as a computer or computational processor) configured for communication with a gaming machine to perform the present disclosure. In a yet another aspect, the present disclosure includes a non-transitory computer readable or carrier medium carrying computer executable code that, when executed on a central processing unit configured for communication with a gaming machine, causes the central processing unit to perform the present disclosure. In this case, the non-transitory carrier medium includes an external hard drive, a memory device, including a memory card, smart card, a radio frequency identification (RFID) device, USB key, magnetic card or other electronic storage device.

While the illustrated embodiments include an electronic display on which the array of game positions is displayed, it will be recognized that the disclosed embodiments could instead incorporate mechanical or electro-mechanical reels to define the array of game positions. In fact, to the extent that the game positions, game symbols or operation of the gaming machine described herein would require a modification of such mechanical or electro-mechanical reels, it will be recognized that the embodiment represents a change in the structure or operation of a machine, rather than simply a variation in the rules of playing a game. In addition or in the alternative, the variation in the game positions, game symbols or operation of the gaming machine described herein may be viewed as analogous to a method for utilizing a new game apparatus (like a new deck of cards), rather than simply as a new set of rules in and of themselves.

It will further be appreciated that any of the features in the preferred embodiments of the present disclosure can be combined together and are not necessarily applied in isolation from each other. For example, the feature of the player being able to selectively starting or stopping spinning of the reels 12 and the feature of providing separate video screens for the lower playing area 7a and upper display area can be combined into a single gaming machine 1. Similar combinations of two or more features from the above described embodiments or embodiments of the present disclosure can be readily made by one skilled in the art.

By providing a bonus prize determined by a selected multiplier and a wager made by the player that is associated with a trigger event, the embodiments of the present disclosure increase the chance of winning bonus prizes in addition to the standard prizes won in a typical game and the amount of those additional bonus prizes. The embodiments of the present disclosure also add greater value to a player in terms of the probability of winning a prize and providing greater variety in game play, especially compared to a conventional gaming machine that only has one set of reels and a single feature game. All these advantages of the present disclosure result in the player being more likely to retain interest in continuing to play the same gaming machine due to the variation in game play on the gaming machine. Furthermore, since the electronic controller controls operation of the gaming machine, the present disclosure can be readily implemented to existing gaming machines, including EGMs, electro-mechanical or purely mechanical gaming machines as well as other gaming systems. In all these respects, the present disclosure represents a practical and commercially significant improvement over the prior art.

In conclusion, although the preceding text sets forth a detailed description of different embodiments of the present disclosure, it should be understood that the legal scope of the present disclosure is defined by the words of the claims set forth at the end of this patent. The detailed description is to be construed as exemplary only and does not describe every possible embodiment of the present disclosure since describing every possible embodiment would be impractical, if not impossible. Numerous alternative embodiments could be implemented, using either current technology or technology developed after the filing date of this patent, which would still fall within the scope of the claims defining the present disclosure.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

1. A gaming machine comprising:
a display; and
an electronic controller coupled to a display;
wherein the gaming machine is configured to receive a wager from a player;
the electronic controller being configured to:
display a first game on the display including one or more configurations of game symbols, one or more of the configurations of game symbols being associated with a winning game outcome, the winning game outcome being associated with a value award payable to a player;
select a multiplier;
calculate a bonus prize value award payable to the player from the multiplier and the wager;
associate the bonus prize value award payable to the player with a trigger event; and
pay the bonus prize value award in response to the trigger event occurring in the first game.

2. The gaming machine of claim 1, wherein the trigger event comprises the appearance of one or more special symbols on the display.

3. The gaming machine of claim 2, wherein as the number of the special symbols increases the probability of awarding a multiplier with a higher amount increases.

4. The gaming machine of claim 1, wherein the trigger event comprises the appearance of a first configuration of game symbols on the display.

5. The gaming machine of claim 1, wherein there are a predetermined number of plays in the first game and the bonus prize value award is paid to the player each time the trigger event occurs in the predetermined number of plays of the first game.

6. The gaming machine of claim 1, wherein the electronic controller randomly selects the multiplier from a range of multipliers, each multiplier having an associated probability of selection, the associated selection probabilities between at least two multipliers being different.

7. The gaming machine of claim 6, wherein there is a plurality of the multiplier ranges, the electronic controller selecting one of multiplier ranges based on the amount of the wager and then selecting the multiplier from the selected multiplier range.

8. The gaming machine of claim 6, wherein the trigger event comprises the appearance of one or more special symbols on the display and there is a plurality of the multiplier ranges, the electronic controller selecting one of multiplier ranges based on the number of special symbols that have appeared on the display.

9. The gaming machine of claim 1, wherein the electronic controller selects the multiplier from a range of multipliers based on a total number of special symbols that have appeared in the first game.

10. The gaming machine of claim 9, wherein each multiplier in the range of multipliers is associated with a threshold number of the special symbols, the electronic controller determines the total number of special symbols and the electronic controller selects the multiplier from the range corresponding to the threshold number that is less than or equal to the total number of special symbols.

11. The gaming machine of claim 1, wherein the wager comprises at least one of a bet option, bet per pay line, total number of pay lines, bet per set of ways and a total bet.

12. The gaming machine of claim 1, wherein the electronic controller is further configured to:
provide an array of game positions in which to display the one or more configurations of game symbols; and
provide the array with one or more non-game symbol positions in which only a non-game symbol can be displayed, the non-game symbol being a symbol that does not form part of any of the one or more configurations of game symbols and wherein there are different types of non-game symbols that are randomly selected for display in the one or more non-game symbol positions;
wherein the trigger event comprises the appearance of a special symbol in the at least one of the non-game symbol positions.

13. A gaming machine comprising:
a display; and
an electronic controller coupled to a display;
wherein the gaming machine is configured to receive a wager from a player;
the electronic controller being configured to:
display a first game on the display including one or more configurations of game symbols, one or more of the configurations of game symbols being associated with one or more winning game outcomes, each winning game outcome being associated with a value award payable to a player;
select a multiplier;
calculate a bonus prize value award payable to the player from the multiplier and the wager;
display a second game in response to the first trigger event occurring in the first game;
associate the bonus prize value award with a second trigger event in the second game; and
pay the bonus prize value award to the player in response to the second trigger event occurring in the second game.

14. The gaming machine of claim 13, wherein the first trigger event comprises the appearance of two or more scatter symbols and the electronic controller randomly selects the multiplier from a range of multipliers, each multiplier having an associated probability of selection, the associated selection probabilities for higher multipliers being greater as the number of the scatter symbols increases.

15. The gaming machine of claim 13, wherein the second trigger event comprises the appearance of one or more special symbols on the display.

16. The gaming machine of claim 13, wherein there are a predetermined number of plays in the second game and the bonus prize value award is paid to the player each time the trigger event occurs in the predetermined number of plays of the second game.

17. The gaming machine of claim 13, wherein the electronic controller selects the multiplier from a range of multipliers, each multiplier having an associated probability of selection, the associated selection probabilities between at least two multipliers being different.

18. The gaming machine of claim 17, wherein there is a plurality of the multiplier ranges, the electronic controller selecting one of multiplier ranges based on the amount of the wager and then selecting the multiplier from the selected multiplier range.

19. The gaming machine of claim 13, wherein the electronic controller selects the multiplier from a range of multipliers based on a total of special symbols that have appeared in the first game.

20. The gaming machine of claim 19, wherein each multiplier in the range of multipliers is associated with a threshold number of the special symbols, the electronic controller determines the total number of special symbols and the electronic controller selects the multiplier from the range corresponding to the threshold number that is less than or equal to the total number of special symbols.

21. The gaming machine of claim 13, wherein the bonus prize value award is paid to the player in response the first trigger event.

22. The gaming machine of claim 13, wherein the wager comprises at least one of a bet option, bet per pay line, total number of pay lines, bet per set of ways and a total bet.

23. The gaming machine of claim 13, wherein the first game comprises a base game and the second game comprises a feature game.
